(19) United States
(12) Patent Application Publication
(10) Pub. No.: US 2026/0323007 A1
(43) Pub. Date: Oct. 15, 2026

(54) CHROMINANCE COMPONENT PREDICTION

(71) Applicant: Tencent Technology (Shenzhen) Company Limited, Shenzhen (CN)

(72) Inventor: Xiaozhong XU, Shenzhen (CN)

(73) Assignee: Tencent Technology (Shenzhen) Company Limited, Shenzhen (CN)

(21) Appl. No.: 19/688,298

(22) Filed: May 26, 2026

Related U.S. Application Data
(63) Continuation of application No. PCT/CN2025/114033, filed on Aug. 12, 2025.

(30) Foreign Application Priority Data
Sep. 14, 2024 (CN) 202411296954.1

(51) Int. Cl. H04N 19/105; H04N 19/159; H04N 19/176; H04N 19/186

(52) U.S. Cl. CPC H04N 19/105; H04N 19/159; H04N 19/176; H04N 19/186

(57) ABSTRACT

In a method of video decoding, a bitstream that includes coded information of a picture is received. The bitstream is decoded to obtain a residual block of a current block in the picture. At least a first prediction of a chrominance component of a first pixel in the current block and a second prediction of the chrominance component of the first pixel are generated by respectively using at least two chrominance intra-frame prediction modes. At least the first prediction and the second prediction are fused to obtain a first predicted chrominance value of the chrominance component of the first pixel. The first pixel in the current block is reconstructed based on the first predicted chrominance value and a first residual value of the first pixel in the residual block of the current block. Apparatus and non-transitory computer-readable storage medium counterpart embodiments are also contemplated.

### RELATED APPLICATIONS

The present application is a continuation of International Application No. PCT/CN2025/114033, filed on Aug. 12, 2025, which claims priority to Chinese Patent Application No. 202411296954.1, filed on Sep. 14, 2024. The entire disclosures of the prior applications are hereby incorporated by reference.

### FIELD OF THE TECHNOLOGY

This disclosure relates to the field of multimedia data processing in computer technologies, including a chrominance component prediction method, a chrominance component prediction apparatus, a computer device, a computer-readable storage medium, and a chrominance component prediction product.

### BACKGROUND

With the advancement of scientific and technological research, computer technologies and Internet technologies have developed rapidly, and a massive amount of multimedia data has emerged on the Internet. Because a transmission resource (for example, bandwidth) is limited, a (coding) device usually codes multimedia data before transmitting the multimedia data, to obtain compressed bitstream data. A coding process involves operations such as predictive coding, transform coding, and quantization. It is found through research that in an intra-frame prediction mode, improving chrominance component prediction accuracy helps improve coding/decoding efficiency. How to improve the chrominance component prediction accuracy has become a hot research issue currently.

### SUMMARY

Embodiments of this disclosure include a chrominance component prediction method and apparatus, a device, a storage medium, and a product, to improve chrominance component prediction accuracy.

Some aspects of the disclosure provide a method of video decoding. In some examples, a bitstream that includes coded information of a picture is received. The bitstream is decoded to obtain a residual block of a current block in the picture. At least a first prediction of a chrominance component of a first pixel in the current block and a second prediction of the chrominance component of the first pixel are generated by respectively using at least two chrominance intra-frame prediction modes. At least the first prediction and the second prediction are fused to obtain a first predicted chrominance value of the chrominance component of the first pixel. The first pixel in the current block is reconstructed based on the first predicted chrominance value of the chrominance component of the first pixel and a first residual value of the first pixel in the residual block of the current block.

Some aspects of the disclosure provide a method of video encoding. In some examples, at least a first prediction of a chrominance component of a first pixel in a current block of a picture and a second prediction of the chrominance component of the first pixel are generated by respectively using at least two chrominance intra-frame prediction modes. At least the first prediction and the second prediction are fused to obtain a first predicted chrominance value of the chrominance component of the first pixel. A first residual value of the first pixel is determined based on the first predicted chrominance value. The current block is encoded into coded information in a bitstream based on at least the first residual value of the first pixel.

Some aspects of the disclosure provide an apparatus that includes processing circuitry configured to perform any of the methods described herein.

Some aspects of the disclosure provide a non-transitory computer-readable storage medium storing instructions which when executed by at least one processor cause the at least one processor to perform any of the methods described herein.

An embodiment of this disclosure provides a chrominance component prediction method, performed by a decoding device and including: obtaining bitstream data of an image; decoding the bitstream data to obtain a residual of a target block and a reference block of the target block; performing prediction based on the reference block by using at least two chrominance intra-frame prediction modes or by using a first luminance coefficient, to obtain a predicted chrominance value of a chrominance component of the target block, the first luminance coefficient being derived based on a pixel in the target block; and reconstructing the image based on the predicted chrominance value of the target block and the residual of the target block.

In this embodiment of this disclosure, the bitstream data of the image is obtained. The bitstream data is decoded to obtain the residual of the target block and the reference block of the target block. Prediction is performed on the chrominance component of the target block based on the reference block and the at least two chrominance intra-frame prediction modes (or based on the reference block and the first luminance coefficient), to obtain the predicted chrominance value of the target block, the first luminance coefficient being derived based on the pixel in the target block. The image is displayed based on the predicted chrominance value of the target block and the residual of the target block. As can be seen, the at least two chrominance intra-frame prediction modes are integrated (or the first luminance coefficient is used) in a chrominance component prediction process, so that a loss caused by quantization can be reduced, improving chrominance component prediction accuracy.

An embodiment of this disclosure provides a chrominance component prediction method, performed by a coding device and including: obtaining a reference block of a to-be-coded target block in an image; performing prediction based on the reference block by using at least two chrominance intra-frame prediction modes or by using a first luminance coefficient, to obtain a predicted chrominance value of a chrominance component of the target block, the first luminance coefficient being derived based on a pixel in the target block; and determining a residual of the target block based on the predicted chrominance value of the target block, and generating bitstream data of the image based on the residual of the target block.

In this embodiment of this disclosure, the reference block of the target block is obtained. Prediction is performed on the chrominance component of the target block based on the reference block and the at least two chrominance intra-frame prediction modes (or based on the reference block and the first luminance coefficient), to obtain the predicted chrominance value of the target block, the first luminance coefficient being derived based on the pixel in the target block. The residual of the target block is determined based on the predicted chrominance value of the target block, the residual of the target block being configured for generating the bitstream data of the image. As can be seen, the at least two chrominance intra-frame prediction modes are integrated (or the first luminance coefficient is used) in a chrominance component prediction process, so that a loss caused by quantization can be reduced, improving chrominance component prediction accuracy.

An embodiment of this disclosure provides a chrominance component prediction apparatus, including: an obtaining unit, configured to obtain bitstream data of an image; and a processing unit, configured to: decode the bitstream data to obtain a residual of a target block and a reference block of the target block; perform prediction based on the reference block by using at least two chrominance intra-frame prediction modes or by using a first luminance coefficient, to obtain a predicted chrominance value of a chrominance component of the target block, the first luminance coefficient being derived based on a pixel in the target block; and reconstruct the image based on the predicted chrominance value of the target block and the residual of the target block.

An embodiment of this disclosure provides a chrominance component prediction apparatus, including: an obtaining unit, configured to obtain a reference block of a to-be-coded target block in an image; and a processing unit, configured to: perform prediction based on the reference block by using at least two chrominance intra-frame prediction modes or by using a first luminance coefficient, to obtain a predicted chrominance value of a chrominance component of the target block, the first luminance coefficient being derived based on a pixel in the target block; and determine a residual of the target block based on the predicted chrominance value of the target block, and generate bitstream data of the image based on the residual of the target block.

This disclosure provides a computer device. The computer device includes: a memory, the memory having a computer program stored therein; and a processor (an example of processing circuitry), configured to load the computer program to implement the chrominance component prediction method of each embodiment.

Correspondingly, this disclosure provides a computer-readable storage medium (e.g., non-transitory computer-readable storage medium). The computer-readable storage medium has a computer program stored therein. The computer program is loaded and executed by a processor to implement the chrominance component prediction method of each embodiment.

This disclosure provides a computer program product or computer program. The computer program product or computer program includes computer instructions. The computer instructions are stored in a computer-readable storage medium. A processor of a computer device reads the computer instructions from the computer-readable storage medium. The processor executes the computer instructions, so that the computer device performs the chrominance component prediction method of each embodiment.

In the embodiments of this disclosure, the coding device and the decoding device both perform, during coding/decoding, prediction on the chrominance component of the target block based on the reference block and the at least two chrominance intra-frame prediction modes (or based on the reference block and the first luminance coefficient), to obtain the predicted chrominance value of the target block. As can be seen, the at least two chrominance intra-frame prediction modes are integrated (or the first luminance coefficient is used) in the chrominance component prediction process, so that the loss caused by quantization can be reduced, improving the chrominance component prediction accuracy and further improving coding/decoding efficiency.

### BRIEF DESCRIPTION OF THE DRAWINGS

FIG. 1 is a schematic diagram of an architecture of a chrominance component prediction system according to an embodiment of this disclosure.

FIG. 2 is a schematic flowchart of video coding/decoding according to an embodiment of this disclosure.

FIG. 3 is a schematic diagram of an angular intra-frame prediction mode according to an embodiment of this disclosure.

FIG. 4 is a schematic flowchart of prediction from multiple cross-component according to an embodiment of this disclosure.

FIG. 5 is a schematic diagram of an intra-frame prediction residual distribution according to an embodiment of this disclosure.

FIG. 6 is a flowchart of a chrominance component prediction method according to an embodiment of this disclosure.

FIG. 7 is a schematic diagram of division into regions according to an embodiment of this disclosure.

FIG. 8 is a flowchart of another chrominance component prediction method according to an embodiment of this disclosure.

FIG. 9 is a schematic diagram of a video live streaming scenario according to an embodiment of this disclosure.

FIG. 10 is a schematic diagram of a video on demand scenario according to an embodiment of this disclosure.

FIG. 11 is a schematic diagram of a structure of a chrominance component prediction apparatus according to an embodiment of this disclosure.

FIG. 12 is a schematic diagram of a structure of another chrominance component prediction apparatus according to an embodiment of this disclosure.

FIG. 13 is a schematic diagram of a structure of a computer device according to an embodiment of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

In the embodiments of this disclosure, the term “module” or “unit” is a computer program with a preset function, or is a part of a computer program and operates, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

“A plurality of” mentioned in this specification means two or more. The term “and/or” describes an association relationship between associated objects and represents that three relationships may exist. For example, A and/or B may represent the following three cases: A exists, both A and B exist, and B exists. The character “/” generally indicates an “or” relationship between the associated objects.

The embodiments of this disclosure relate to a multimedia data processing technology and to a process of coding/decoding video content. The video content mentioned in the embodiments of this disclosure may be video content that is generated in real time and needs to be transmitted in real time in a process such as video live streaming or video conferencing. Alternatively, the video content may be video content that does not need to be generated and transmitted in real time in a scenario such as video on demand or short video content. Video coding is a technology for coding the video content, to convert the video content into a file with a smaller size, thereby obtaining a video bitstream corresponding to the video content. Video decoding is a technology for decoding a video bitstream, which is a reverse process of video coding, to restore the video bitstream into uncompressed video content, thereby obtaining video content corresponding to the video bitstream.

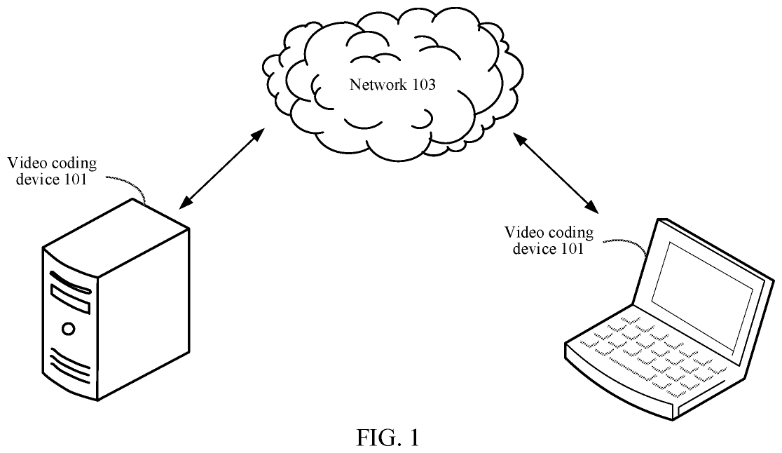

FIG. 1 is a schematic diagram of an architecture of a chrominance component prediction system according to an embodiment of this disclosure. As shown in FIG. 1, the chrominance component prediction system includes a video coding device 101 and a video decoding device 102. The video coding device 101 and the video decoding device 102 are video processing devices. The video coding device 101 may be a video processing device that produces video content. After producing the video content, the video coding device 101 may perform video coding on the video content to obtain a video bitstream. The video coding device 101 may transmit the video bitstream to the video decoding device 102. The video decoding device 102 may receive the video bitstream transmitted by the video coding device 101, and decode the video bitstream to obtain video content corresponding to the video bitstream. The video coding device 101 may be an electronic device used by a provider of the video content (for example, a producer of the video content). The video decoding device 102 may be an electronic device used by a user of the video content (for example, a user).

The video coding device 101 and the video decoding device 102 may directly or indirectly communicate with each other by using a wired or wireless connection. For example, as shown in FIG. 1, the video coding device 101 and the video decoding device 102 may communicate with each other by using a network 103. The video coding device 101 may perform unidirectional data transmission with the video decoding device 102 based on the network 103. For example, the video coding device 101 may code the video content, and transmit the video content to the video decoding device 102 by using the network 103. The coded video content is transmitted in a form of a video bitstream. The video decoding device 102 may obtain the video bitstream based on the network 103, decode the video bitstream to restore the video content, and further display the video content based on the restored video content.

In an example, the video coding device 101 may perform bidirectional data transmission with the video decoding device 102 based on the network 103. Bidirectional data transmission may occur in a process such as video live streaming or video conferencing. For bidirectional data transmission, the video coding device 101 may code the video content (for example, a video image stream acquired by the video coding device 101) in real time, and transmit the coded video bitstream to the video decoding device 102 in real time by using the network 103. The video decoding device 102 may receive the video bitstream transmitted by the video coding device 101, decode the video bitstream to restore the video content, and display a video image in the video image stream on an accessible display apparatus based on the video content.

A quantity and forms of the devices shown in FIG. 1 are used as an example, and do not constitute a limitation on the embodiments of this disclosure. In an actual application, the video processing devices (for example, the video coding device 101 and the video decoding device 102) may be a same electronic device, or may be different electronic devices. This is not limited in this disclosure. The network 103 may include, for example, a wired communication network and/or a wireless communication network. The network 103 may exchange data in a circuit-switched channel and/or a packet-switched channel. The network may include a telecommunication network, a local area network, a wide area network, and/or the Internet. For an objective of this disclosure, an architecture and a topology of the network 103 may be insignificant for operations disclosed in this disclosure, unless explained below.

The video processing device (for example, the video coding device 101 and the video decoding device 102) may be but is not limited to a smartphone, a tablet computer, a notebook computer, a desktop computer, a smart speaker, a smartwatch, a smart voice interaction device, a smart appliance, an in-vehicle terminal, a virtual reality (VR) device, or an aircraft. Alternatively, the video processing device (for example, the video coding device 101 and the video decoding device 102) may be a server, for example, may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), or a big data and artificial intelligence platform.

Processing performed by the video coding device 101 mainly includes: (1) a process of obtaining and producing the video content; and (2) a video coding process. Processing performed by the video decoding device 102 mainly includes: (3) a video decoding process. There is a transmission process of the video bitstream between the video coding device 101 and the video decoding device 102. The transmission process may be performed according to various transmission protocols. The transmission protocols herein may include but are not limited to a dynamic adaptive streaming over HTTP (DASH) protocol, an HTTP live streaming (HLS) protocol, the smart media transport protocol (SMTP), the transmission control protocol (TCP), and the like.

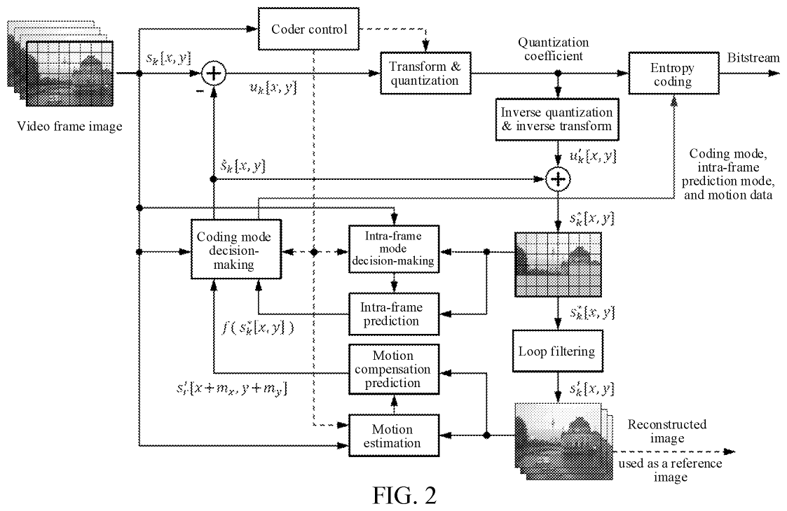

FIG. 2 is a schematic flowchart of video coding according to an embodiment of this disclosure.

### 1. Process of Obtaining and Producing the Video Content

The video content may be obtained in two manners: a capture device acquires a sound and a visual scene in a real world, and an electronic device generates the video content. The capture device may be a hardware component configured in the video coding device 101. For example, the capture device may include a microphone, a camera, and various sensors, such as an active radar sensor. The capture device may also directly or indirectly communicate with the video coding device 101 by using a wired connection or a wireless connection. For example, the video coding device 101 is a server, and the capture device is a camera or the like connected to the server, and is configured to provide the video content to the video coding device 101. The capture device may include a camera device and a sensing device, and may further include an audio device, configured to obtain audio content synchronized with the video content. For example, the camera device may include an ordinary camera, a depth camera, and a light field camera. The sensing device may include a laser device, a radar device, and the like. The audio device may include an audio sensor, a microphone, and the like. The capture device is deployed at a specific location in a real space, to capture video content in the space and audio content synchronized with the video content.

### 2. Video Coding Process

The video coding device 101 performs video coding on an obtained video signal (video content). The video signal (video content) may be understood as color mode (red, green, blue, RGB) video data/luminance-bandwidth-chrominance (YUV) video data. For example, in high efficiency video coding (HEVC) (an international video coding standard), versatile video coding (VVC) (an international video coding standard), and audio video coding standard (AVS) (a Chinese national video coding standard), a hybrid coding framework is used, and the following series of operations and processing are performed on an input original video signal.

### (1) Image Partition/Block Partition Structure

After a video frame image is input, the video frame image is divided into several non-overlapping processing units based on a block size, and a similar compression operation is performed on each processing unit. The processing unit is referred to as a coding tree unit (CTU) or a largest coding unit (LCU). The CTU is configured for dividing an image into blocks that can be processed independently, thereby improving coding efficiency and parallelism. In VVC, the CTU has a size of 128×128, and can be further subdivided into one or more basic coding units (CUs). The CU is a most basic element in a coding phase.

### (2) Predictive Coding

Predictive coding includes manners such as intra-frame prediction and inter-frame prediction. A coder side needs to determine a predictive coding mode to be selected for a current code unit (or code block), and inform the video decoding device 102.
a. Intra-frame prediction means that a predicted signal is from a region that has been reconstructed through coding in a same image.

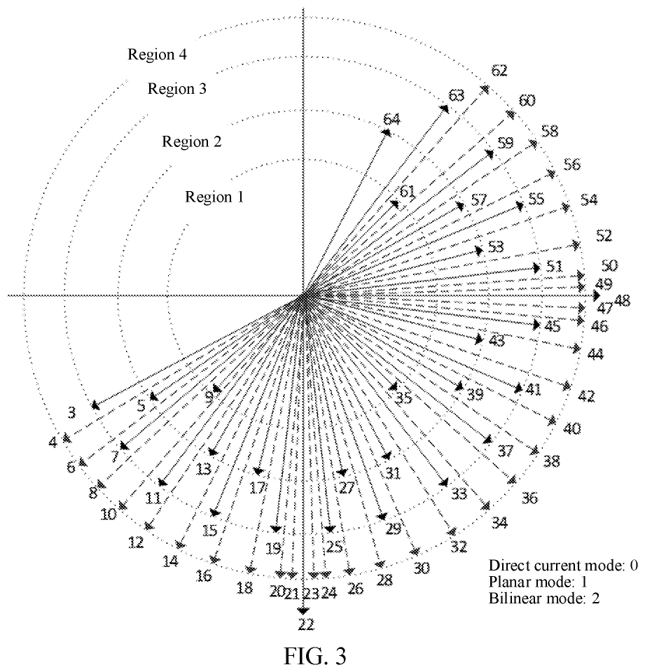

The intra-frame prediction mode includes a non-angular intra-frame prediction mode (for example, planar, DC, and bilinear) and an angular intra-frame prediction mode. FIG. 3 is a schematic diagram of an angular intra-frame prediction mode according to an embodiment of this disclosure. As shown in FIG. 3, when the angular intra-frame prediction mode is used, for a pixel in a current prediction block, a reference pixel value at a corresponding location in a reference pixel row or a reference pixel column is used as a predicted value based on a direction corresponding to an angle of the prediction mode. For a pixel P in the prediction block, a location of a reference pixel is first determined from an upper coded pixel row based on the prediction angle in the figure, and then a value of the reference pixel is used as a predicted value of the pixel P. Not all reference pixel locations to which pixel locations point are of integer pixel precision. For example, the reference pixel location of the pixel P is a sub-pixel location between a pixel B and a pixel C. In this case, the predicted pixel value of the pixel P needs to be obtained through interpolation by using surrounding pixels. An intra-frame prediction sub-pixel interpolation filter may perform interpolation by using spatial correlation of pixels, to obtain pixel values at sub-pixel locations of reference pixels, thereby obtaining more accurate predicted values. In addition to a linear interpolation function, the intra-frame prediction sub-pixel interpolation filter also has a smoothing filtering function. Smoothing filtering can relieve impact of noise on intra-frame prediction, help concentration of energy after transform, and improve coding efficiency.

Intra-frame prediction may include luminance component prediction and chrominance component prediction. The following describes several common chrominance intra-frame prediction modes.

### I. Chroma Intra Prediction Mode (CIPM)

Similar to a luminance intra-frame prediction mode, intra-frame prediction for a chrominance component can also generate an intra-frame prediction block of a current chrominance block by using an adjacent reference pixel based on a directional prediction mode (for example, horizontal, vertical, or diagonal) or a non-directional prediction mode (for example, DC or planar).

### II. Two-Step Cross-Component Prediction Mode (TSCPM)

In the chrominance intra-frame prediction mode, after a luminance block is reconstructed, a linear model is established, and a chrominance prediction block (Cb, Cr) at a corresponding location is generated by using a luminance reconstruction block (Rec_Y) at a corresponding location as an input, specifically expressed as follows:

Pred_{C}=α×Rec_{γ}+β Formula (1)

α and β are linear model parameters obtained through calculation based on reconstructed pixels (luminance and chrominance) in a template region of the current block. Rec_{γ} and Pred_{C} are the luminance reconstruction block (that is, a reference block) and the chrominance prediction block. The template region of the target block is an adjacent coded or reconstructed region in the current image that is located outside a target block, for example, a region on the left of the target block and a region on the upper of the target block.
III. Prediction from Multiple Cross-Component (PMC) Mode

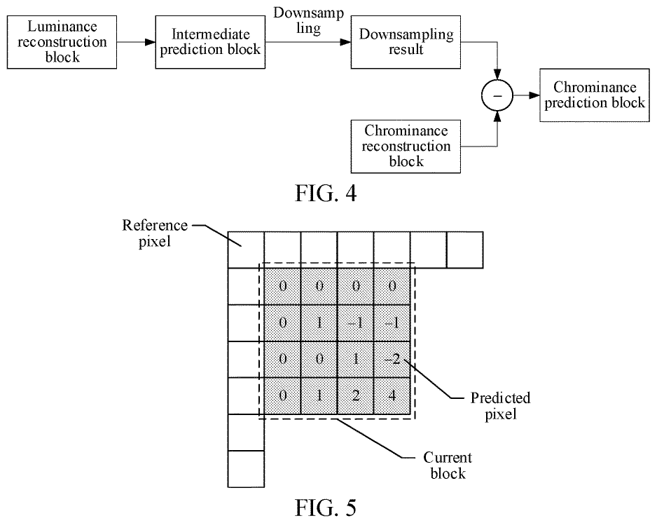

The prediction from multiple cross-component mode is a chrominance intra-frame prediction mode. In the chrominance intra-frame prediction mode, after both a luminance block and a Cb chrominance block are reconstructed, a linear model is established, and a Cr chrominance prediction block at a corresponding location is generated by using a luminance reconstruction block (Rec_{γ}) and a Cb chrominance reconstruction block at a corresponding location as an input. FIG. 4 is a schematic flowchart of prediction from multiple cross-component according to an embodiment of this disclosure. As shown in FIG. 4, an intermediate prediction block IPred is first obtained based on the luminance reconstruction block Rec_{γ}. Then, the intermediate prediction block IPred is downsampled to obtain IPred′. Then, a difference between IPred′ and the Cb chrominance reconstruction block Rec_{Cb} is calculated to obtain the Cr chrominance prediction block FPred_{Cr}. The foregoing process may be specifically expressed as follows:

IPred=A·Rec_{γ}+B Formula (2)

FPred_{Cr}=IPred′−Rec_{Cb} Formula (3)

A and B are linear model parameters obtained through calculation based on reconstructed pixels (luminance and chrominance) in a template region of the current block. Rec_{γ} is the luminance reconstruction block (that is, a reference block). IPred is the intermediate prediction block output by the linear model. IPred′ is a downsampling result of IPred. Rec_{Cb} is the Cb chrominance reconstruction block. FPred_{Cr} is the Cr chrominance prediction block.
b. Inter-frame prediction means that a predicted signal is from another coded image (referred to as a reference image) different from the current image. Because adjacent video frames usually have a great similarity, for a to-be-coded image block (for example, the foregoing CU), the reference image may be searched for a reference block, and an image residual and location information of the reference block are recorded.

### (3) Transform and Quantization

Some transform coefficients are obtained after a residual block is transformed and quantized. The transform coefficients are inversely quantized and inversely transformed to obtain a residual signal, and then an intra-frame prediction pixel is superposed to obtain a reconstructed pixel. Due to quantization, the reconstructed residual signal may be different from a difference between an original pixel and a predicted pixel. In some cases, a reference pixel is from a region on the left of a current block and a region above the current block. For example, the reference pixel may be one or more columns of pixels located on the left of the current block and one or more columns of pixels located above the current block in the image. For pixels in a left/upper region of the current block, because the pixels are close to and in strong statistical correlation with the reference pixels, an absolute value of a residual generated through prediction is small. For pixels located in a lower/right region of the current block, because the pixels are far away from the reference pixels, an absolute value of a prediction residual is large. FIG. 5 is a schematic diagram of an intra-frame prediction residual distribution according to an embodiment of this disclosure. As shown in FIG. 5, the current block includes a plurality of pixels (predicted pixels). A value of a pixel is a value of a prediction residual of the pixel, and prediction residuals of pixels at different locations may be the same or different. Usually, (an absolute value of) a prediction residual of a pixel farther away from a reference pixel is larger.

After a transform operation such as discrete Fourier transform (DFT) or discrete cosine transform (DCT) is performed on a residual video signal, the signal is converted into a transform domain, to obtain a transform coefficient. A lossy quantization operation is performed on the transform coefficient, with some information lost. Therefore, a quantized signal is beneficial to compression and expression. In some video coding standards, two or more transform modes may be selected. Therefore, the coder side also needs to select one of the transform modes for a current coding unit (or code block), and inform a decoder side. Quantization fineness is usually determined by a quantization parameter (QP). A larger value of the QP indicates quantization of coefficients in a larger value range into a same output, usually resulting in larger distortion and a lower bit rate. On the contrary, a small value of the QP indicates quantization of coefficients in a small value range into a same output, usually bringing small distortion and a corresponding high bit rate.

### (4) Entropy Coding or Statistical Coding

Statistical compressed coding is performed on a quantized transform domain signal based on a frequency of occurrence of each value, to finally output a binary (0 or 1) compressed bitstream. In addition, entropy coding also needs to be performed on other information generated through coding, for example, a selected coding mode and motion vector data, to reduce a code rate. Statistical coding is a lossless coding mode capable of effectively reducing a code rate required for expressing a same signal. A common statistical coding mode includes variable length coding (VLC) or content adaptive binary arithmetic coding (CABAC).

A CABAC process mainly includes three steps: binarization, context modeling, and binary arithmetic coding. After binarization processing is performed on an input syntactic element, binary data may be coded in a normal coding mode and a bypass coding mode. In the bypass coding mode, a probabilistic model does not need to be assigned to each binary bit, and a bin value of the input binary bit is directly coded with a simple bypass coder, to accelerate coding and decoding. Generally, different syntactic elements are not completely independent of each other, and a same syntactic element has memorability to some extent. Therefore, according to a conditional entropy theory, compared with independent coding or memoryless coding, conditional coding with another coded syntactic element can further improve coding performance. Coded sign information used as a condition is referred to as a context. In the normal coding mode, binary bits of the syntactic element enter a context modeler in sequence, and a coder assigns an appropriate probabilistic model for each input binary bit based on a value of a previously coded syntactic element or binary bit. This process is context modeling. A context model corresponding to a syntactic element may be positioned by using a context index increment (ctxIdxInc) and a context index start (ctxIdxStart). After the bin value and the assigned probabilistic model are transmitted to a binary arithmetic coder together for coding, the context model needs to be updated based on the bin value, which is an adaptive process in coding.

### (5) Loop Filtering

Inverse quantization, inverse transform, and predictive compensation operations are performed on a transformed and quantized signal to obtain a reconstructed image. Due to impact of quantization, compared with an original image, some information of the reconstructed image is different from that of the original image, that is, the reconstructed image may have a distortion. Therefore, a filtering operation such as deblocking filter (DBF), a sample adaptive offset (SAO), or adaptive loop filter (ALF) may be performed on the reconstructed image to effectively reduce a degree of distortion generated by quantization. Since a filtered reconstructed image is used as a reference for subsequent image coding to predict a future picture signal, the filtering operation is also referred to as loop filtering, that is, a filtering operation in a coding loop.

Currently, mainstream video coding standards such as HEVC, VVC, AV1 (a first-generation video coding standard developed by the Open Media Alliance), AV2 (a second-generation video coding standard developed by the Open Media Alliance), and AVS3 (a third-generation video coding standard developed by the Open Media Alliance) all use a block-based hybrid coding framework. In some examples, original video content is divided into a series of code blocks, and video data is compressed by combining video coding methods such as prediction, transform, and entropy coding.

In an embodiment of this disclosure, FIG. 2 is a basic flowchart of a video coder. In this procedure, intra-frame prediction is used as an example for description. A difference operation is performed on an original image signal sₖ[x,y] and a predicted image signal ŝₖ[x,y] to obtain a residual signal uₖ[x,y]. The residual signal uₖ[x,y] is transformed and quantized to obtain a quantization coefficient. On the one hand, entropy coding is performed on the quantization coefficient to obtain a coded bitstream. On the other hand, inverse quantization and inverse transform are performed to obtain a reconstructed residual signal u′ₖ[x,y]. The predicted image signal ŝₖ[x,y] and the reconstructed residual signal u′ₖ[x,y] are superposed to generate an image signal

$${s}_{k}^{*} [ x , y ] .$$

On the one hand, the image signal

$${s}_{k}^{*} [ x , y ]$$

is input into an intra-frame mode decision-making module and an intra-frame prediction module for intra-frame prediction. On the other hand, a reconstructed image signal s′ₖ[x,y] is output through loop filtering. The reconstructed image signal s′ₖ[x,y] may be used as a reference image of a next frame for motion estimation and motion compensation prediction. Then, a predicted image signal ŝₖ[x,y] of the next frame is obtained based on a motion compensation prediction result s′ᵣ[x+mₓ, y+m_{y}] and an intra-frame prediction result

$$f ( {s}_{k}^{*} [ x , y ] ) ,$$

and the foregoing process continues to be repeated until coding is completed.

### 3. Video Decoding Process

A decoding process of the video decoding device 102 is a reverse of the coding process of the video coding device 101. It may be learned from the foregoing video coding process that when the video decoding device 102 performs video decoding, for each CU, after obtaining a compressed bitstream, a content playback device first performs entropy decoding to obtain various types of mode information (an MV, motion estimation information, and the like) and a quantized transform coefficient. Inverse quantization and inverse transform are performed on each coefficient to obtain a residual signal (residual data). In addition, a predicted signal corresponding to the CU may be obtained based on known coding mode information, and after the predicted signal is added to the CU, a reconstructed signal may be obtained. Finally, a loop filtering operation needs to be performed on a reconstructed value of the decoded image to generate a final output signal, that is, the restored video content.

In an implementation, the video bitstream and the video content (each video frame) may both be stored in a blockchain, to prevent the video bitstream and the video content (each video frame) from being tampered with. The blockchain is a novel application mode of computer technologies such as distributed data storage, point-to-point transmission, a consensus mechanism, and an encryption algorithm. The blockchain is essentially a decentralized database, and is a string of data blocks associatively generated by using a cryptographic method. Each data block includes information of a batch of network transactions, and is configured for verifying validity of the information (anti-counterfeiting) and generating a next block.

The chrominance component prediction system described in the embodiments of this disclosure is intended to describe the technical solutions in the embodiments of this disclosure, and does not constitute a limitation on the technical solutions provided in the embodiments of this disclosure. A person of ordinary skill in the art may know that with evolution of a system architecture and emergence of a new service scenario, the technical solutions provided in the embodiments of this disclosure are also applicable to a similar technical problem.

Based on the foregoing chrominance component prediction system, an embodiment of this disclosure provides a chrominance component prediction method. The chrominance component prediction method described in this embodiment of this disclosure may be performed by a computer device. The computer device may be a video processing device (for example, the video coding device 101 and the video decoding device 102) in the chrominance component prediction system shown in FIG. 1. The video coding device 101 and the video decoding device 102 may be a same computer device (that is, the computer device has both a coding function and a decoding function).

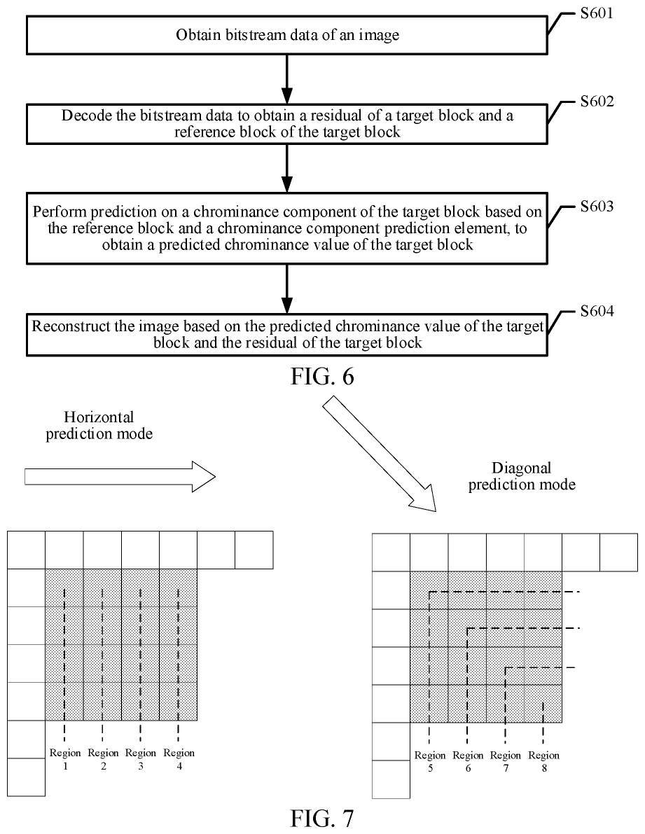

FIG. 6 is a flowchart of a chrominance component prediction method according to an embodiment of this disclosure. The chrominance component prediction method may be performed by a decoding device. The chrominance component prediction method may include the following operation S601 to operation S604.
S601: Obtain bitstream data of an image.

The bitstream data is obtained by a coding device by coding the image. The image may be independent, or may be a frame of a video, a live streaming image, or the like. This is not limited in this disclosure.
S602: Decode the bitstream data to obtain a residual of a target block and a reference block of the target block.

The target block is any unreconstructed block in the image. The target block may include one or more basic coding units. The reference block may include one or more reference pixels, and the reference pixels are reconstructed pixels in the image. A decoding process of the bitstream data is a reverse process of a coding process. For a specific implementation in which the decoding device decodes the bitstream data to obtain the residual of the target block and the reference block of the target block, refer to the foregoing encoding/decoding process, and details are not described herein again.
S603: Perform prediction on a chrominance component of the target block based on the reference block and a chrominance component prediction element, to obtain a predicted chrominance value of the target block.

The chrominance component prediction element is at least two chrominance intra-frame prediction modes or a first luminance coefficient of the target block. In this operation, the decoding device performs prediction based on the reference block by using the at least two chrominance intra-frame prediction modes or by using the first luminance coefficient, to obtain the predicted chrominance value of the chrominance component of the target block.

The first luminance coefficient is derived based on a pixel in the target block. A value of the first luminance coefficient may be used as values of α and β in Formula (1) (for example, when the TSCPM is used for chrominance component prediction), may be used as values of A and B in Formula (2) (for example, when the PMC is used for chrominance component prediction), or may be used as a value of another coefficient that acts on a luminance reconstruction block (for example, a luminance component reconstruction sample) (for example, used as a filter coefficient value).

In the embodiments of this disclosure (including various implementations in the claims and the specification, which are referred to as the embodiments of this disclosure), the chrominance component prediction element is the at least two chrominance intra-frame prediction modes. In other words, the decoding device integrates the at least two chrominance intra-frame prediction modes to perform prediction on the chrominance component of the target block. The decoding device performs prediction on the chrominance component of the target block by using each of the at least two chrominance intra-frame prediction modes, to obtain a predicted value of the chrominance component of the target block in each chrominance intra-frame prediction mode. The decoding device may fuse the predicted values of the chrominance component of the target block in the chrominance intra-frame prediction modes, to obtain the predicted chrominance value of the chrominance component of the target block.

In the embodiments of this disclosure, reference data used by different chrominance intra-frame prediction modes in the at least two chrominance intra-frame prediction modes is from different locations and/or different color channels in the image, so that advantages of different prediction modes are integrated to avoid a problem of inadequate prediction accuracy of a single prediction mode at some locations or in some cases. For example, the at least two chrominance intra-frame prediction modes may include an intra-frame prediction mode based on an adjacent region and an intra-frame prediction mode based on another reconstructed color component of a current block. The intra-frame prediction mode based on an adjacent region may include, for example, various directional prediction modes. The intra-frame prediction mode based on another reconstructed color component of a current block may include, for example, an intra-frame prediction mode based on a reconstructed luminance component and/or another reconstructed chrominance component of a current block, such as the PMC and the TSCPM. The chrominance intra-frame prediction mode may include but is not limited to the CIPM, the TSCPM, PMC, and a directional intra-frame prediction mode.

In the embodiments of this disclosure, a manner of fusing the predicted values of the chrominance component that correspond to different prediction modes by using a preset algorithm may be partition-based decision, weighted summation, partition-based weighted summation, or the like.

For example, prediction results in different prediction modes may be selected for pixels or regions at different positions. The target block may be divided into at least two regions (a division manner may be determined based on an actual situation). Each region includes at least one pixel. A prediction mode to be used for each region is determined for the region based on a relative location of each region and characteristics of different prediction modes. For example, the directional intra-frame prediction mode is determined to be used for a region close (relative to another region or relative to a preset threshold) to a reconstructed adjacent block, and the intra-frame prediction mode based on at least one another reconstructed color component of a current block is determined to be used for a region far (relative to another region or relative to the preset threshold) away from the reconstructed adjacent block.

For another example, different weights may be preset for different prediction modes, and then weighted summation is performed on prediction results in different prediction modes. A weight value is a value greater than 0. For example, the at least two chrominance intra-frame prediction modes include a first chrominance intra-frame prediction mode and a second chrominance intra-frame prediction mode. The decoding device performs prediction on the chrominance component of the target block based on the reference block and the first chrominance intra-frame prediction mode, to obtain a predicted value (a first predicted value for short) of the target block in the first chrominance intra-frame prediction mode. The decoding device performs prediction on the chrominance component of the target block based on the reference block and the second chrominance intra-frame prediction mode, to obtain a predicted value (a second predicted value for short) of the target block in the second chrominance intra-frame prediction mode. After obtaining the first predicted value of the target block and the second predicted value of the target block, the decoding device performs weighted summation on the first predicted value and the second predicted value to obtain the predicted chrominance value of the target block, specifically expressed as follows:

P_final=w*P1+(1−w)*P2 Formula (4)

P_final is the predicted chrominance value of the target block. P1 is the predicted chrominance value of the target block in the first chrominance intra-frame prediction mode. P2 is the predicted chrominance value of the target block in the second chrominance intra-frame prediction mode. w is a weight value between 0 and 1. For example, P1 may be a predicted chrominance value in the directional intra-frame prediction mode, and P2 may be a predicted chrominance value in a cross-component intra-frame prediction mode.

In the embodiments of this disclosure, the weight may be a weight value of a prediction mode corresponding to a pixel or a region in the target block. In a pixel or a region, when a weight corresponding to a mode is 0, a predicted value of the pixel or the region is not obtained by using the mode. For example, when the target block includes a plurality of pixels or is divided into at least two regions, weight values corresponding to a same prediction mode in the pixels or the regions may be different. A weight corresponding to each prediction mode may be preset or derived for each pixel or each region in the target block. The decoding device may determine, for each of the at least two regions, a weight corresponding to each of the at least two chrominance intra-frame prediction modes, and merge, for the weight corresponding to each chrominance intra-frame prediction mode in each region, predicted values of the chrominance component that correspond to the at least two chrominance intra-frame prediction modes in the region, to obtain a predicted chrominance value of each region. For example, for each pixel or each region, weighted summation may be performed on prediction results in different prediction modes, as shown in Formula (5):

$${P}_{j} = {\sum }_{n = 1}^{N} {w}_{jn} {P}_{jn} \qquad Formula ( 5 )$$

Pⱼ is a j^{th} pixel or region in the current target block, where j=1, 2, . . . , or M, and M is a total quantity of pixels or regions in the target block. wⱼₙ is a weight value corresponding to an n^{th} chrominance intra-frame prediction mode in an n^{th} pixel or region, and Pⱼₙ is a predicted value of the n^{th} pixel or region obtained based on the n^{th} chrominance intra-frame prediction mode, where n=1, 2, . . . , or N, and N is a total quantity of chrominance intra-frame prediction modes used. In this way, the predicted chrominance value of the target block is a set {Pⱼ} of predicted values of the pixels or the regions, where j=1, 2, . . . , or M.

In another embodiment, the target block may be divided into at least two regions (for example, based on a distance between (a reference pixel in) the reference block and a predicted pixel in the target block). Different chrominance intra-frame prediction modes correspond to different weights in different regions. The decoding device may perform, by using a weight value of each chrominance intra-frame prediction mode in each region, weighting processing on the predicted value of the chrominance component of the target block that is obtained by using the chrominance intra-frame prediction mode, and then merge weighting processing results corresponding to the chrominance intra-frame prediction modes. For example, when the target block includes a first region and a second region, after obtaining the first predicted value of the target block corresponding to the first chrominance intra-frame prediction mode and the second predicted value of the target block corresponding to the second chrominance intra-frame prediction mode, the decoding device weights (a predicted value for the first region and a predicted value for the second region in) the first predicted value by using a first weight corresponding to the first chrominance intra-frame prediction mode in the first region and a second weight corresponding to the first chrominance intra-frame prediction mode in the second region, to obtain a first weighting result of the first region and a second weighting result of the second region. The decoding device weights (a predicted value for the first region and a predicted value for the second region in) the second predicted value by using a third weight corresponding to the second chrominance intra-frame prediction mode in the first region and a fourth weight corresponding to the second chrominance intra-frame prediction mode in the second region, to obtain a third weighting result of the first region and a fourth weighting result of the second region. After obtaining the first weighting result, the second weighting result, the third weighting result, and the fourth weighting result, the decoding device sums (weighted predicted values of a same pixel in) the first weighting result, the second weighting result, the third weighting result, and the fourth weighting result to obtain a summation result of the first region and the second region, that is, obtain the predicted chrominance value of the target block.

In the foregoing example, the first weight, the second weight, the third weight, and the fourth weight are represented as w1 to w4, where w1 to w4 may be the same; or one part of w1 to w4 may be the same, and the other part of w1 to w4 may be different (for example, w1 and w3 are different, and w2 and w4 are the same); or w1 to w4 may be different from each other. In addition, when the target block is divided into the first region and the second region, and a value of any one of w1 to w4 is 0, the predicted chrominance value of the corresponding region is obtained through prediction by using one chrominance intra-frame prediction mode. For example, when w1 is 0 (w3 is not 0), the predicted chrominance value of the first region is obtained through prediction by using the second chrominance intra-frame prediction mode. When w2 is 0 (w4 is not 0), the predicted chrominance value of the first region is obtained through prediction by using the first chrominance intra-frame prediction mode. When w1 and w4 are both 0 (w2 and w3 are not 0), the predicted chrominance value of the first region is obtained through prediction by using the second chrominance intra-frame prediction mode, and the predicted chrominance value of the second region is obtained through prediction by using the first chrominance intra-frame prediction mode.

In the embodiments of this disclosure, the weight may alternatively be at least two weight values in a manner of dividing the target block into regions in a prediction mode. Each intra-frame prediction mode may have an independent block division manner. In other words, the target block may be divided in different manners in different intra-frame prediction modes, that is, different intra-frame prediction modes may have different weight distribution. Weight values of the intra-frame prediction modes in the pixels or the regions in the target block may be separately determined. The weight values corresponding to the intra-frame prediction modes may be represented, for example, in a form of a weight matrix, a weight map, or a weight-region correspondence table. For example, in each intra-frame prediction mode, the target block may be divided into at least two regions (a division manner may be configured based on a characteristic of the intra-frame prediction mode). For example, for the directional intra-frame prediction mode, the target block may be divided into at least two regions based on a distance between each pixel in the target block and (the reference pixel in) the reference block, and each region includes at least one pixel. Weights of intra-frame prediction modes corresponding to different regions are different. The decoding device may perform, by using a weight value set corresponding to each intra-frame prediction mode, weighting on the predicted value of the chrominance component of the target block that is obtained by using the intra-frame prediction mode, and then merge weighting processing results corresponding to the intra-frame prediction modes. For example, in the first chrominance intra-frame prediction mode, the target block includes a first region and a second region; and in the second chrominance intra-frame prediction mode, the target block includes a third region, a fourth region, and a fifth region. The decoding device may separately obtain a first predicted value of the target block corresponding to the first chrominance intra-frame prediction mode and a second predicted value of the target block corresponding to the second chrominance intra-frame prediction mode. The decoding device separately weights a predicted value of the first region and a predicted value of the second region in the first predicted value by using a first weight corresponding to the first chrominance intra-frame prediction mode in the first region and a second weight corresponding to the first chrominance intra-frame prediction mode in the second region, to obtain a first weighting result of the target block. The decoding device separately weights predicted values of the third region, the fourth region, and the fifth region in the second predicted value by using a third weight corresponding to the second chrominance intra-frame prediction mode in the third region, a fourth weight corresponding to the second chrominance intra-frame prediction mode in the fourth region, and a fifth weight corresponding to the second chrominance intra-frame prediction mode in the fifth region, to obtain a second weighting result of the target block. The decoding device sums weighted predicted values corresponding to a same pixel in the first weighting result and the second weighting result, to obtain the predicted chrominance value of the target block.

In other words, different intra-frame prediction modes may correspond to different policies for division into regions. For example, after the first predicted value of the target block corresponding to the first chrominance intra-frame prediction mode and the second predicted value of the target block corresponding to the second chrominance intra-frame prediction mode are obtained, the target block is first divided by using a first division policy corresponding to the first chrominance intra-frame prediction mode, to obtain a region 1 and a region 2 (the target block is divided into two regions) corresponding to the first chrominance intra-frame prediction mode, and the first predicted value is separately weighted by using w1 corresponding to the region 1 and w2 corresponding to the region 2, to obtain a weighting result 1 and a weighting result 2. Then, the target block is divided by using a second division policy corresponding to the second chrominance intra-frame prediction mode, to obtain a region 3 to a region 5 (the target block is divided into three regions), and the second predicted value is separately weighted by using w3 corresponding to the region 3, w4 corresponding to the region 4, and w5 corresponding to the region 5, to obtain a weighting result 3 to a weighting result 5. Then, the predicted chrominance value of the target block is determined based on the weighting result 1 to the weighting result 5.

FIG. 7 is a schematic diagram of division into regions according to an embodiment of this disclosure. As shown in FIG. 7, for the directional chrominance intra-frame prediction mode, when chrominance intra-frame prediction is performed based on a horizontal direction, the target block may be divided into a region 1 to a region 4 (the quantity of regions is used as an example) based on the horizontal direction, and based on distances to the reference pixel in the horizontal direction, weights may be configured as follows: a weight for the region 1> a weight for the region 2> a weight for the region 3> a weight for the region 4. When chrominance intra-frame prediction is performed based on a diagonal direction, the target block may be divided into a region 5 to a region 8 (the quantity of regions is used as an example) based on the diagonal direction, and based on distances to the reference pixel in the diagonal direction, weights may be configured as follows: a weight for the region 5> a weight for the region 6> a weight for the region 7> a weight for the region 8. In addition, for a non-directional chrominance intra-frame prediction mode, a same weight or a different weight may be set for each region.

In the embodiments of this disclosure, when the chrominance component prediction element is the first luminance coefficient of the target block, the decoding device performs prediction on the chrominance component of the target block based on the reference block and the first luminance coefficient.

In the embodiments of this disclosure, the decoding device determines the first luminance coefficient of the target block by using a second luminance coefficient of the target block and a luminance difference value. The second luminance coefficient of the target block is derived based on a pixel (not belonging to the target block) in a template region of the target block. The template region of the target block may include but is not limited to the region on the left of the target block and the region above the target block. The luminance difference value is configured for indicating a difference between the first luminance coefficient of the target block and the second luminance coefficient of the target block. A value of the second luminance coefficient of the target block may be used as values of α and β in Formula (1), may be used as values of A and B in Formula (2), or may be used as a value of another coefficient that acts on the luminance reconstruction block. A difference lies in that determining the first luminance coefficient of the target block by using the second luminance coefficient of the target block and the luminance difference value may be specifically expressed as any one of the following formulas:

c_{i_final}=c_{i_derived}+c_{i_delta} Formula (6)

c_{i_final}=c_{i_derived}*(1+cᵢ_{_{delta}}) Formula (7)

c_{i_final} is the first luminance coefficient of the target block. c_{i_derived} is the second luminance coefficient of the target block. cᵢ_{_{delta}} is the luminance difference value.

The decoding device obtains the luminance difference value. The decoding device may decode a value code and a sign code in the bitstream data that correspond to the luminance difference value, to obtain the luminance difference value. Alternatively, the decoding device may determine the luminance difference value from a value index table based on index information carried in the bitstream data.

In the embodiments of this disclosure, the coding device may quantize the luminance difference value in a quantization manner, and indicate a quantization result of the luminance difference value by using the value code (for example, fixed four bits) and the sign code (for example, a 1-bit identifier). The decoding device may perform inverse quantization on the value code and the sign code in the bitstream data that correspond to the luminance difference value, to obtain the luminance difference value.

In the embodiments of this disclosure, the coding device and the decoding device may store the value index table of the luminance difference value. The coding device indicates the index information (for example, an index value) of the luminance difference value by using the bitstream data. After decoding the bitstream data, the decoding device determines the luminance difference value based on the index information and the value index table of the luminance difference value. For the value index table of the luminance difference value, refer to Table 1 or Table 2.

TABLE 1

| Index information | 0 | 1 | 2 | 3 | 4 | 5 | 6 | 7 | 8 |
|---|---|---|---|---|---|---|---|---|---|
| Luminance | 0 | 1/16 | − 1/16 | ⅛ | −⅛ | ¼ | −¼ | ½ | −½ |
| difference value | | | | | | | | | |
| Bit string | 0 | 10 | 110 | 1110 | 11110 | 111110 | 1111110 | 111111110 | 111111110 |

TABLE 2

| Index information | 0 | 1 | 2 | 3 | 4 |
|---|---|---|---|---|---|
| Luminance difference value | 0 | 1/16 | ⅛ | ¼ | ½ |
| Bit string | 0 | 10 | 110 | 1110 | 1111 |

A difference between Table 1 and Table 2 lies in that Table 1 carries a sign (that is, a positive/negative sign) of the luminance difference value, and Table 2 is used for determining the luminance difference value. When Table 2 is used as the value index table of the luminance difference value, the sign of the luminance difference value needs to be additionally identified.

In the embodiments of this disclosure, the coding device performs entropy coding on the luminance difference value, and for an obtained target bit string, may perform CABAC context model design on a value of an i^{th} bit in the target bit string. The target bit string is configured for indicating the luminance difference value, and i is a positive integer. For example, (a value of an i^{th} bit in) a target bit string of a luminance difference value of a previous block may be considered as a context of (the value of the i^{th} bit in) the target bit string of the luminance difference value of the target block. Correspondingly, the decoding device decodes entropy coded data of the luminance difference value in the bitstream data, to obtain the luminance difference value.

After obtaining the luminance difference value, the decoding device calculates the first luminance coefficient of the target block based on the second luminance coefficient of the target block and the luminance difference value. For a specific implementation, refer to Formula (6) or Formula (7), and details are not described herein again. Then, the decoding device determines the predicted chrominance value of the target block based on the reference block (for example, the luminance reconstruction block of the target block) and the first luminance coefficient of the target block. With reference to Formula (1), a value of the first luminance coefficient of the target block is used as the values of α and β, and the predicted chrominance value of the target block may be directly calculated based on the luminance reconstruction block (Rec_{γ}), α, and β. With reference to Formula (2) and Formula (3), the value of the first luminance coefficient of the target block is used as the values of A and B. The decoding device first calculates an intermediate prediction block based on the luminance reconstruction block (Rec_{γ}), A, and B, and then determines the predicted chrominance value of the target block by using a downsampling result of the intermediate prediction block and a Cb chrominance reconstruction block of the target block.

In the embodiments of this disclosure, the target block may be divided into at least two regions. For example, the at least two regions include a first region and a second region. After obtaining the luminance difference value and the second luminance coefficient of the target block, the decoding device calculates a predicted chrominance value of the first region based on the reference block (for example, the luminance reconstruction block of the target block) and the first luminance coefficient of the target block. The decoding device further calculates a predicted chrominance value of the second region based on the reference block (for example, the luminance reconstruction block of the target block) and the second luminance coefficient of the target block. After obtaining the predicted chrominance value of the first region and the predicted chrominance value of the second region, the decoding device determines the predicted chrominance value of the target block based on the predicted chrominance value of the first region and the predicted chrominance value of the second region.

For example, for pixels located in first M rows and first N columns (that is, pixels in the second region) in the target block (W columns*H rows), the decoding device uses the value of the second luminance coefficient (which may be represented as c_{i_derived}) of the target block as the values of α and β (or the values of A and B) in a cross-component chrominance mode (a two-step cross-component prediction mode or a prediction from multiple cross-component mode), and performs chrominance component prediction on the pixels in the second region by using the cross-component chrominance mode, to obtain the predicted chrominance value of the second region. For remaining pixels (that is, pixels in the first region) in the target block, the decoding device uses the first luminance coefficient (which may be represented as c_{i_final}) of the target block as the values of α and β (or the values of A and B) in the cross-component chrominance mode (the two-step cross-component prediction mode or the prediction from multiple cross-component mode), and performs chrominance component prediction on the pixels in the first region by using the cross-component chrominance mode, to obtain the predicted chrominance value of the first region. W and H are integers greater than 1, Mis a positive integer less than W, and Nis a positive integer less than H.

For another example, for pixels located in first H/T rows and first W/S columns (that is, pixels in the second region) in the target block (W columns*H rows), the decoding device uses the value of the second luminance coefficient (which may be represented as c_{i_derived}) of the target block as the values of α and β (or the values of A and B) in a cross-component chrominance mode (a two-step cross-component prediction mode or a prediction from multiple cross-component mode), and performs chrominance component prediction on the pixels in the second region by using the cross-component chrominance mode, to obtain the predicted chrominance value of the second region. For remaining pixels (that is, pixels in the first region) in the target block, the decoding device uses the first luminance coefficient (which may be represented as c_{i_final}) of the target block as the values of α and β (or the values of A and B) in the cross-component chrominance mode (the two-step cross-component prediction mode or the prediction from multiple cross-component mode), and performs chrominance component prediction on the pixels in the first region by using the cross-component chrominance mode, to obtain the predicted chrominance values of the first region. W and H are integers greater than 1, and T and S are powers of 2.

For another example, the target block (W columns*H rows) is divided in a direction from the top right to the bottom left, to generate a top-left region and a bottom-right region. For the top-left region (that is, the second region), the value of the second luminance coefficient (which may be represented as c_{i_derived}) of the target block is used as the values of α and β (or the values of A and B) in a cross-component chrominance mode (a two-step cross-component prediction mode or a prediction from multiple cross-component mode), and chrominance component prediction is performed on pixels in the second region by using the cross-component chrominance mode, to obtain the predicted chrominance value of the second region. For the bottom-right region (that is, pixels in the first region) in the target block, the decoding device uses the first luminance coefficient (which may be represented as c_{i_final}) of the target block as the values of α and β (or the values of A and B) in the cross-component chrominance mode (the two-step cross-component prediction mode or the prediction from multiple cross-component mode), and performs chrominance component prediction on the pixels in the first region by using the cross-component chrominance mode, to obtain the predicted chrominance values of the first region. Areas of the top-left region and the bottom-right region may be different.

In the embodiments of this disclosure, the target block may be divided into at least two regions. For example, the target block is divided into a first region and a second region. The decoding device reconstructs a part of pixels in the target block (for example, pixels in the first region in the target block) by using a second luminance coefficient of the target block, and derives the first luminance coefficient of the target block based on the reconstructed pixels (for example, the pixels in the target block). The second luminance coefficient of the target block is derived based on a pixel (not included in the target block) in a template region of the target block. In some examples, the decoding device reconstructs the pixels in the first region by using the second luminance coefficient of the target block. After obtaining the pixels in the first region, the decoding device derives the first luminance coefficient of the target block based on the reconstructed pixels in the first region. After obtaining the first luminance coefficient of the target block, the decoding device determines predicted chrominance values of remaining pixels (for example, pixels in the second region) in the target block by using the first luminance coefficient of the target block. The determining a predicted chrominance value of the second region by using the first luminance coefficient of the target block may include: determining a luminance reconstruction block of the second region based on the reconstructed pixel in the first region, and determining the predicted chrominance value of the second region based on the luminance reconstruction block of the second region and the first luminance coefficient of the target block; or using the first luminance coefficient of the target block as a coefficient of a filter, and performing prediction on the chrominance component of the second region via the filter, to obtain the predicted chrominance value of the second region.

In the embodiments of this disclosure, the decoding device uses a value of the first luminance coefficient of the target block as the values of α and β (or the values of A and B) in a cross-component chrominance mode (a two-step cross-component prediction mode or a prediction from multiple cross-component mode), and determines the predicted chrominance values of the remaining pixels (for example, the pixels in the second region) in the target block by using the cross-component chrominance mode. For a specific implementation, refer to Formula (1), or refer to Formula (2) and Formula (3), and details are not described herein again.

For example, for pixels located in first H/T rows and first W/S columns (that is, the pixels in the first region) in the target block (W columns*H rows), the decoding device may use a value of the second luminance coefficient of the target block as a coefficient value of the filter, and reconstruct the pixels in the first region via the filter. For remaining pixels (that is, the pixels in the second region) in the target block, the decoding device derives the value of the first luminance coefficient (which may be represented as c_{i_final}) of the target block as the values of α and β (or the values of A and B) in the cross-component chrominance mode (the two-step cross-component prediction mode or the prediction from multiple cross-component mode) based on reconstructed pixels in the first region, and performs chrominance component prediction on the pixels in the second region by using the cross-component chrominance mode, to obtain the predicted chrominance value of the second region. W and H are integers greater than 1, and T and S are powers of 2.

For another example, the target block (W columns*H rows) is divided in a direction from the top right to the bottom left, to generate a top-left region and a bottom-right region. For the top-left region (that is, the first region), the value of the second luminance coefficient (which may be represented as c_{i_derived}) of the target block is used as the values of α and β (or the values of A and B) in a cross-component chrominance mode (a two-step cross-component prediction mode or a prediction from multiple cross-component mode), and the pixels in the first region are reconstructed by using the cross-component chrominance mode. For the bottom-right region (that is, the pixels in the second region) in the target block, the decoding device derives the value of the first luminance coefficient (which may be represented as c_{i_final}) of the target block as the values of α and β (or the values of A and B) in the cross-component chrominance mode (the two-step cross-component prediction mode or the prediction from multiple cross-component mode) based on reconstructed pixels in the first region, and performs chrominance component prediction on the pixels in the second region by using the cross-component chrominance mode, to obtain the predicted chrominance value of the second region. Areas of the top-left region and the bottom-right region may be different.

In the embodiments of this disclosure, the decoding device may use a value of the first luminance coefficient of the target block as a coefficient value of a filter, and perform chrominance component prediction on the pixels in the second region via the filter, to obtain the predicted chrominance value of the second region. For example, for pixels located in first M rows and first N columns (that is, the pixels in the first region) in the target block (W columns*H rows), the decoding device uses a value of the second luminance coefficient (which may be represented as c_{i_derived}) of the target block as the values of α and β (or the values of A and B) in a cross-component chrominance mode (a two-step cross-component prediction mode or a prediction from multiple cross-component mode), and reconstructs the pixels in the first region by using the cross-component chrominance mode. For remaining pixels (that is, the pixels in the second region) in the target block, the decoding device derives the first luminance coefficient (which may be represented as c_{i_final}) of the target block based on reconstructed pixels in the first region, then uses the value of the first luminance coefficient of the target block as the coefficient value of the filter, and performs chrominance component prediction on the pixels in the second region via the filter, to obtain the predicted chrominance value of the second region. W and H are integers greater than 1, M is a positive integer less than W, and N is a positive integer less than H.

The first luminance coefficient of the target block (also referred to as current block in some examples) is derived by using the reconstructed pixel in the target block. A luminance difference value does not need to be indicated during coding/decoding.
S604: Reconstruct the image based on the predicted chrominance value of the target block and the residual of the target block.

The decoding device obtains an intra-frame prediction result of the target block based on the predicted chrominance value of the target block, reconstructs the target block by using the intra-frame prediction result and the residual of the target block, reconstructs the image based on a reconstructed target block, and displays a reconstructed image (also referred to as a display image) via a display device. For a specific implementation of operation S604, refer to the foregoing video decoding process, and details are not described herein again.

In the embodiments of this disclosure, the bitstream data of the image is obtained. The bitstream data is decoded to obtain the residual of the target block and the reference block of the target block. Prediction is performed on the chrominance component of the target block based on the reference block and the at least two chrominance intra-frame prediction modes (or based on the reference block and the first luminance coefficient), to obtain the predicted chrominance value of the target block, the first luminance coefficient being derived based on the pixel in the target block. The image is reconstructed for display based on the predicted chrominance value of the target block and the residual of the target block. As can be seen, the at least two chrominance intra-frame prediction modes are integrated (or the first luminance coefficient is used) in a chrominance component prediction process, so that a loss caused by quantization can be reduced, improving chrominance component prediction accuracy.

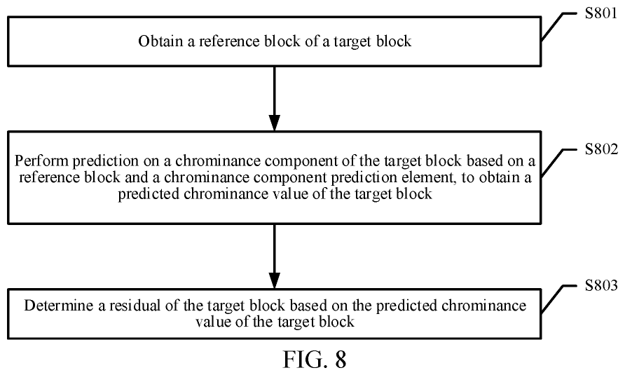

FIG. 8 is a flowchart of a chrominance component prediction method according to an embodiment of this disclosure. The chrominance component prediction method may be performed by a coding device. The chrominance component prediction method may include the following operation S801 to operation S803.
S801: Obtain a reference block of a to-be-coded target block in an image.

The target block is any uncoded block in the image. The target block may include one or more basic coding units. The image may be independent, or may be a frame of a video, a live streaming image, or the like. This is not limited in this disclosure. The reference block of the target block may include one or more reference pixels, and the reference pixels are reconstructed pixels in the image.
S802: Perform prediction on a chrominance component of the target block based on the reference block and a chrominance component prediction element, to obtain a predicted chrominance value of the target block.

The chrominance component prediction element is at least two chrominance intra-frame prediction modes or a first luminance coefficient of the target block. In other words, the coding device performs prediction on the chrominance component of the target block by using the at least two chrominance intra-frame prediction modes or by using the first luminance coefficient. The first luminance coefficient is derived based on a pixel in the target block. A value of the first luminance coefficient may be used as values of α and β in Formula (1) (for example, when the TSCPM is used for chrominance component prediction), may be used as values of A and B in Formula (2) (for example, when the PMC is used for chrominance component prediction), or may be used as a value of another coefficient that acts on a luminance reconstruction block (for example, a luminance component reconstruction sample) (for example, used as a filter coefficient value).

In the embodiments of this disclosure, the chrominance component prediction element is the at least two chrominance intra-frame prediction modes. In other words, the coding device integrates the at least two chrominance intra-frame prediction modes to perform prediction on the chrominance component of the target block. Reference data used by a first chrominance intra-frame prediction mode and reference data used by a second chrominance intra-frame prediction mode in the at least two chrominance intra-frame prediction modes are from different locations and/or different color channels in the image. The chrominance intra-frame prediction mode may include but is not limited to the CIPM, the TSCPM, PMC, and a directional intra-frame prediction mode. For a specific implementation in which the coding device performs prediction on the chrominance component of the target block based on the reference block and the at least two chrominance intra-frame prediction modes, to obtain the predicted chrominance value of the target block, refer to the implementation in FIG. 6 in which the decoding device performs prediction on the chrominance component of the target block based on the reference block and the at least two chrominance intra-frame prediction modes, to obtain the predicted chrominance value of the target block, and details are not described herein.

In the embodiments of this disclosure, the chrominance component prediction element is the first luminance coefficient of the target block. In other words, the coding device performs prediction on the chrominance component of the target block based on the reference block and the first luminance coefficient. A difference between the coding device and a decoding device lies in that the coding device may directly derive the first luminance coefficient of the target block based on the target block, and the decoding device needs to determine the first luminance coefficient of the target block based on a second luminance coefficient of the target block and a luminance difference value, or the decoding device reconstructs a part of pixels in the target block based on a second luminance coefficient of the target block, and then derives the first luminance coefficient of the target block by using reconstructed pixels in the target block. For example, the coding device may determine the first luminance coefficient based on a pixel value in the target block; determine the second luminance coefficient of the target block based on a pixel value in a template region of the target block; determine a luminance difference value between the first luminance coefficient and the second luminance coefficient; and code the luminance difference value into bitstream data of the image. For another example, the target block includes at least two regions. The coding device may reconstruct a pixel in a first region in the at least two regions by using the second luminance coefficient of the target block; determine the first luminance coefficient of the target block based on the reconstructed pixel in the first region; and determine a predicted chrominance value of a second region in the at least two regions by using the first luminance coefficient of the target block. The bitstream data of the image includes no luminance difference value between the first luminance coefficient and the second luminance coefficient.

For a specific implementation in which the coding device performs prediction on the chrominance component of the target block based on the reference block (for example, the luminance reconstruction block of the target block) and the first luminance coefficient of the target block, to obtain the predicted chrominance value of the target block, refer to the implementation in FIG. 6 in which the decoding device performs prediction on the chrominance component of the target block based on the reference block and the first luminance coefficient of the target block, to obtain the predicted chrominance value of the target block, and details are not described herein.
S803: Determine a residual of the target block based on the predicted chrominance value of the target block.

The residual of the target block is configured for generating the bitstream data of the image. For a specific implementation in which the coding device determines the residual of the target block based on the predicted chrominance value of the target block, and generates the bitstream data of the image based on the residual of the target block, refer to the foregoing video coding process, and details are not described herein again.

In the embodiments of this disclosure, the coding device indicates the first luminance coefficient of the target block by using the luminance difference value. The coding device may calculate a difference value between the first luminance coefficient of the target block and the second luminance coefficient of the target block according to Formula (6) or Formula (7), to obtain the luminance difference value; and then add indication information of the luminance difference value to the bitstream data of the image. The indication information of the luminance difference value includes a value code and a sign code that correspond to the luminance difference value, or includes index information of the luminance difference value. For a specific coding/decoding mode, refer to a coding/decoding implementation of the luminance difference value in FIG. 6, and details are not described herein again.

In this embodiment of this disclosure, the reference block of the target block is obtained. Prediction is performed on the chrominance component of the target block based on the reference block and the at least two chrominance intra-frame prediction modes (or based on the reference block and the first luminance coefficient), to obtain the predicted chrominance value of the target block, the first luminance coefficient being derived based on the pixel in the target block. The residual of the target block is determined based on the predicted chrominance value of the target block, the residual of the target block being configured for generating the bitstream data of the image. As can be seen, the at least two chrominance intra-frame prediction modes are integrated (or the first luminance coefficient is used) in a chrominance component prediction process, so that a loss caused by quantization can be reduced, improving chrominance component prediction accuracy.

The foregoing describes a specific execution process of the chrominance component prediction method and the chrominance component prediction system suitable for implementing the chrominance component prediction method. The following describes scenarios to which the chrominance component prediction method is applicable.

### (1) Video Live Streaming Scenario

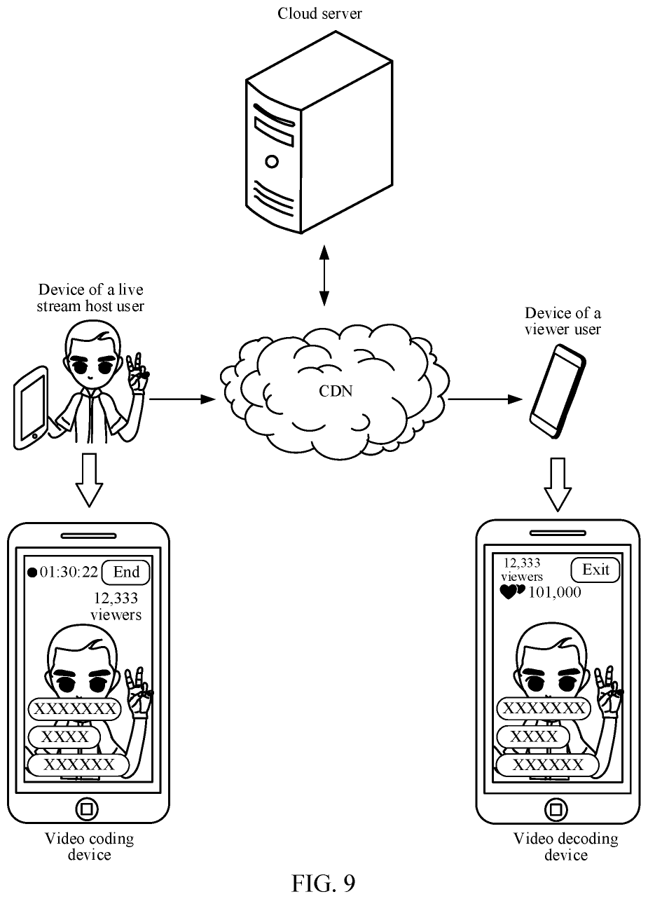

FIG. 9 is a schematic diagram of a video live streaming scenario according to an embodiment of this disclosure. As shown in FIG. 9, in the video live streaming scenario, a video coding device may be an electronic device used by a live stream host user. The video coding device may provide functions of video production and video coding. A video live streaming application may run on the video coding device. A video decoding device is an electronic device used by a viewer user viewing live streaming of the live stream host. The video decoding device may provide a function of decoding a video bitstream, to render and play obtained video content. The video coding device and the video decoding device each may be a device including a CPU and a GPU, and are configured to perform video coding/decoding.

The video coding device may obtain video content, and perform video coding to obtain a video bitstream. The video coding device may push, by using a streaming tool, a video encapsulation file encapsulated with the video bitstream to a cloud server by using the RTMP. After the cloud server receives the video encapsulation file, the cloud server may decode the video encapsulation file based on a user requirement, and further perform processing such as transcoding, denoising, enhancement, and analysis. Alternatively, the video coding device may push, by using a streaming tool, a video encapsulation file to a CDN by using the RTMP, and the cloud server may pull the video encapsulation file from the CDN, and process the video encapsulation file based on a user requirement. Then, the video decoding device of the viewer user may pull the video encapsulation file by using the live video streaming application, decapsulate and decode the video encapsulation file, render, based on a display parameter, the video content obtained through decoding, and further display (play) the video content of the video bitstream.

In the video live streaming scenario, the video coding device and the video decoding device can improve chrominance component prediction accuracy by using the chrominance component prediction method, thereby improving coding/decoding efficiency.

### (2) Video on Demand Scenario

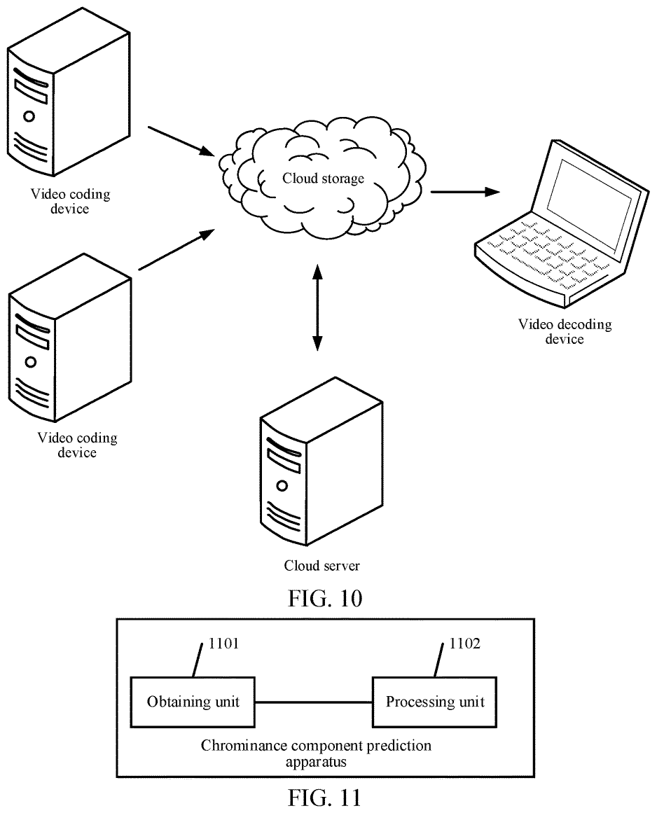

Video on demand (VOD) means playing corresponding video content based on a requirement of a viewer user, which may also be understood as transmitting content that the user wants to view (click or select) to the requesting user. FIG. 10 is a schematic diagram of a video on demand scenario according to an embodiment of this disclosure. As shown in FIG. 10, in the video on demand scenario, a video coding device may be a platform that provides video content or an electronic device used by a user. The video coding device may provide functions of performing video production, video coding, and video encapsulation on a video. A video decoding device is an electronic device used by a viewer user using a video on demand function. The video decoding device may provide a function of decoding a video bitstream, to render and play the video. The video coding device and the video decoding device each may be a device including a CPU and a GPU, and are configured to perform video coding/decoding.

In some examples, the video coding device may perform video coding on video content to obtain a video bitstream. Further, the video coding device may store a video encapsulation file encapsulated with the video bitstream in a cloud storage, for example, a cloud server. Further, the video decoding device may obtain a corresponding video encapsulation file from the cloud storage based on video content that the user selects to view, decapsulate and decode the video encapsulation file, render, based on a display parameter, the video content obtained through decoding, and further display (play) the video content of the video bitstream.

In the video on demand scenario, the video coding device and the video decoding device can also improve chrominance component prediction accuracy by using the chrominance component prediction method, thereby improving coding/decoding efficiency.

The foregoing describes the method in the embodiments of this disclosure in further detail. For ease of implementing the foregoing solutions of the embodiments of this disclosure better, correspondingly, the following provides an apparatus in the embodiments of this disclosure.

FIG. 11 is a schematic diagram of a structure of a chrominance component prediction apparatus according to an embodiment of this disclosure. The chrominance component prediction apparatus shown in FIG. 11 may be mounted on a computer device. The computer device may be specifically a decoding device. The chrominance component prediction apparatus shown in FIG. 11 may be configured to perform a part or all of the functions in the method embodiment shown in FIG. 6. Referring to FIG. 11, the chrominance component prediction apparatus includes: an obtaining unit 1101, configured to obtain bitstream data of an image; and a processing unit 1102, configured to: decode the bitstream data to obtain a residual of a target block and a reference block of the target block, the target block being any unreconstructed block in the image; perform prediction on a chrominance component of the target block based on the reference block and a chrominance component prediction element, to obtain a predicted chrominance value of the target block, the chrominance component prediction element being at least two chrominance intra-frame prediction modes or a first luminance coefficient of the target block, and the first luminance coefficient being derived based on a pixel in the target block; and display the image based on the predicted chrominance value of the target block and the residual of the target block.

In an implementation, the chrominance component prediction element is the at least two chrominance intra-frame prediction modes. When performing prediction on the chrominance component of the target block based on the reference block and the chrominance component prediction element, to obtain the predicted chrominance value of the target block, the processing unit 1102 is specifically configured to: perform prediction on the chrominance component of the target block based on the reference block and a first chrominance intra-frame prediction mode, to obtain a first predicted value of the target block; perform prediction on the chrominance component of the target block based on the reference block and a second chrominance intra-frame prediction mode, to obtain a second predicted value of the target block; and perform weighted summation on the first predicted value and the second predicted value to obtain the predicted chrominance value of the target block.

In an implementation, the target block includes a first region and a second region. When performing weighted summation on the first predicted value and the second predicted value, to obtain the predicted chrominance value of the target block, the processing unit 1102 is specifically configured to: weight the first predicted value separately by using a first weight corresponding to the first region and a second weight corresponding to the second region, to obtain a first weighting result and a second weighting result; weight the second predicted value separately by using a third weight corresponding to the first region and a fourth weight corresponding to the second region, to obtain a third weighting result and a fourth weighting result; and sum the first weighting result, the second weighting result, the third weighting result, and the fourth weighting result to obtain the predicted chrominance value of the target block.

In an implementation, the chrominance component prediction element is the first luminance coefficient of the target block. When performing prediction on the chrominance component of the target block based on the reference block and the chrominance component prediction element, to obtain the predicted chrominance value of the target block, the processing unit 1102 is specifically configured to: obtain a luminance difference value, the luminance difference value being configured for indicating a difference between the first luminance coefficient of the target block and a second luminance coefficient of the target block, and the second luminance coefficient of the target block being derived based on a pixel in a template region of the target block; calculate the first luminance coefficient of the target block based on the second luminance coefficient of the target block and the luminance difference value; and determine the predicted chrominance value of the target block based on the reference block and the first luminance coefficient of the target block.

In an implementation, the target block includes a first region and a second region. When determining the predicted chrominance value of the target block based on the reference block and the first luminance coefficient of the target block, the processing unit 1102 is specifically configured to: calculate a predicted chrominance value of the first region based on the reference block and the first luminance coefficient of the target block; calculate a predicted chrominance value of the second region based on the reference block and the second luminance coefficient of the target block; and determine the predicted chrominance value of the target block based on the predicted chrominance value of the first region and the predicted chrominance value of the second region.

In an implementation, the chrominance component prediction element is the first luminance coefficient of the target block, and the target block includes a first region and a second region. A process in which the processing unit 1102 performs prediction on the chrominance component of the target block based on the reference block and the chrominance component prediction element, to obtain the predicted chrominance value of the target block includes: reconstructing a pixel in the first region by using a second luminance coefficient of the target block, the second luminance coefficient of the target block being derived based on a pixel in a template region of the target block; deriving the first luminance coefficient of the target block based on the reconstructed pixel in the first region; and determining a predicted chrominance value of the second region by using the first luminance coefficient of the target block.

In an implementation, when determining the predicted chrominance value of the second region by using the first luminance coefficient of the target block, the processing unit 1102 is specifically configured to: determine a luminance reconstruction block of the second region based on the reconstructed pixel, and determine the predicted chrominance value of the second region based on the luminance reconstruction block of the second region and the first luminance coefficient of the target block; or use the first luminance coefficient of the target block as a coefficient of a filter, and perform prediction on the chrominance component of the second region via the filter, to obtain the predicted chrominance value of the second region.

According to an embodiment of this disclosure, a part of operations in the chrominance component prediction method shown in FIG. 6 may be performed by the units in the chrominance component prediction apparatus shown in FIG. 11. For example, operation S601 shown in FIG. 6 may be performed by the obtaining unit 1101 shown in FIG. 11, and operation S602 to operation S604 may be performed by the processing unit 1102 shown in FIG. 11. The units in the chrominance component prediction apparatus shown in FIG. 11 may be separately or all combined into one or several other units, or one (or some) of the units may be further split into a plurality of smaller function units, so that same operations can be implemented without affecting implementation of the technical effects of the embodiments of this disclosure. The foregoing units are obtained through division based on logical functions. In an actual application, a function of one unit may be implemented by a plurality of units, or functions of a plurality of units may be implemented by one unit. In another embodiment of this disclosure, the chrominance component prediction apparatus may further include another unit. In an actual application, the functions may alternatively be implemented with assistance of the another unit, and may be implemented by a plurality of units in cooperation.

According to another embodiment of this disclosure, a computer program (including program code) capable of performing each operation in the corresponding method shown in FIG. 6 may be run in a general-purpose compute apparatus, for example, a computer device, including a processing element and a storage element such as a central processing unit (CPU), a random access memory (RAM), and a read-only memory (ROM), to structure the chrominance component prediction apparatus shown in FIG. 11 and implement the chrominance component prediction method in the embodiments of this disclosure. The computer program may be recorded in, for example, a computer-readable recording medium and loaded, by using the computer-readable recording medium, and run on the computer apparatus.

Based on a same inventive concept, a problem resolving principle and beneficial effects of the chrominance component prediction apparatus provided in this embodiment of this disclosure are similar to a problem resolving principle and beneficial effects of the chrominance component prediction method in the method embodiment of this disclosure. Refer to the principle and the beneficial effects of implementation of the method. For brevity of description, details are not described herein again.

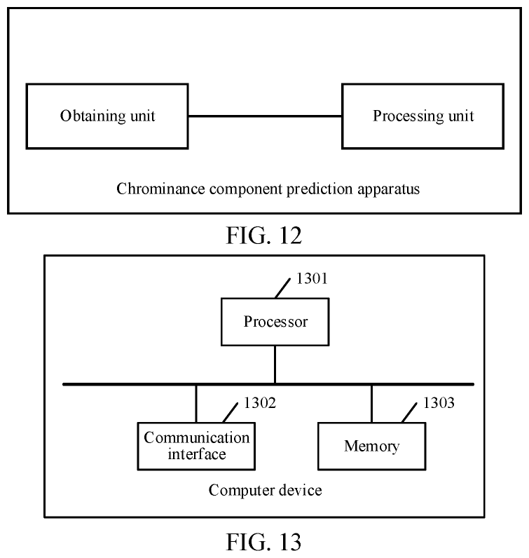

FIG. 12 is a schematic diagram of a structure of another chrominance component prediction apparatus according to an embodiment of this disclosure. The chrominance component prediction apparatus shown in FIG. 12 may be mounted on a computer device. The computer device may be specifically a coding device. The chrominance component prediction apparatus shown in FIG. 12 may be configured to perform a part or all of the functions in the method embodiment shown in FIG. 8. Referring to FIG. 12, the chrominance component prediction apparatus includes: an obtaining unit 1201, configured to obtain a reference block of a target block, the target block being any uncoded block in an image; and a processing unit 1202, configured to: perform prediction on a chrominance component of the target block based on the reference block and a chrominance component prediction element, to obtain a predicted chrominance value of the target block, the chrominance component prediction element being at least two chrominance intra-frame prediction modes or a first luminance coefficient of the target block, and the first luminance coefficient being derived based on a pixel in the target block; and determine a residual of the target block based on the predicted chrominance value of the target block, the residual of the target block being configured for generating bitstream data of the image.

In an implementation, the chrominance component prediction element is the at least two chrominance intra-frame prediction modes. When performing prediction on the chrominance component of the target block based on the reference block and the chrominance component prediction element, to obtain the predicted chrominance value of the target block, the processing unit 1202 is specifically configured to: perform prediction on the chrominance component of the target block based on the reference block and a first chrominance intra-frame prediction mode, to obtain a first predicted value of the target block; perform prediction on the chrominance component of the target block based on the reference block and a second chrominance intra-frame prediction mode, to obtain a second predicted value of the target block; and perform weighted summation on the first predicted value and the second predicted value to obtain the predicted chrominance value of the target block.

In an implementation, the target block includes a first region and a second region. When performing weighted summation on the first predicted value and the second predicted value, to obtain the predicted chrominance value of the target block, the processing unit 1202 is specifically configured to: weight the first predicted value separately by using a first weight corresponding to the first region and a second weight corresponding to the second region, to obtain a first weighting result and a second weighting result; weight the second predicted value separately by using a third weight corresponding to the first region and a fourth weight corresponding to the second region, to obtain a third weighting result and a fourth weighting result; and sum the first weighting result, the second weighting result, the third weighting result, and the fourth weighting result to obtain the predicted chrominance value of the target block.

In an implementation, the chrominance component prediction element includes the first luminance coefficient of the target block. When performing prediction on the chrominance component of the target block based on the reference block and the chrominance component prediction element, to obtain the predicted chrominance value of the target block, the processing unit 1202 is specifically configured to: determine the predicted chrominance value of the target block based on the reference block and the first luminance coefficient of the target block.

In an implementation, the target block includes a first region and a second region. When determining the predicted chrominance value of the target block based on the reference block and the first luminance coefficient of the target block, the processing unit 1202 is specifically configured to: derive a second luminance coefficient of the target block based on a pixel value in a template region of the target block; calculate a predicted chrominance value of the first region based on the reference block and the first luminance coefficient of the target block; calculate a predicted chrominance value of the second region based on the reference block and the second luminance coefficient of the target block; and determine the predicted chrominance value of the target block based on the predicted chrominance value of the first region and the predicted chrominance value of the second region.

According to an embodiment of this disclosure, a part of operations in the chrominance component prediction method shown in FIG. 8 may be performed by the units in the chrominance component prediction apparatus shown in FIG. 12. For example, operation S801 shown in FIG. 8 may be performed by the obtaining unit 1201 shown in FIG. 12, and operation S802 and operation S803 may be performed by the processing unit 1202 shown in FIG. 12. The units in the chrominance component prediction apparatus shown in FIG. 12 may be separately or all combined into one or several other units, or one (or some) of the units may be further split into a plurality of smaller function units, so that same operations can be implemented without affecting implementation of the technical effects of the embodiments of this disclosure. The foregoing units are obtained through division based on logical functions. In an actual application, a function of one unit may be implemented by a plurality of units, or functions of a plurality of units may be implemented by one unit. In another embodiment of this disclosure, the chrominance component prediction apparatus may further include another unit. In an actual application, the functions may alternatively be implemented with assistance of the another unit, and may be implemented by a plurality of units in cooperation.

According to another embodiment of this disclosure, a computer program (including program code) capable of performing each operation in the corresponding method shown in FIG. 8 may be run in a general-purpose compute apparatus, for example, a computer device, including a processing element and a storage element such as a CPU, a RAM, and a ROM, to structure the chrominance component prediction apparatus shown in FIG. 12 and implement the chrominance component prediction method in the embodiments of this disclosure. The computer program may be recorded in, for example, a computer-readable recording medium and loaded, by using the computer-readable recording medium, and run on the computer apparatus.

Based on a same inventive concept, a problem resolving principle and beneficial effects of the chrominance component prediction apparatus provided in this embodiment of this disclosure are similar to a problem resolving principle and beneficial effects of the chrominance component prediction method in the method embodiment of this disclosure. Refer to the principle and the beneficial effects of implementation of the method. For brevity of description, details are not described herein again.

FIG. 13 is a schematic diagram of a structure of a computer device according to an embodiment of this disclosure. The computer device may be a coding device or a decoding device. As shown in FIG. 13, the computer device includes at least a processor 1301, a communication interface 1302, and a memory 1303. The processor 1301, the communication interface 1302, and the memory 1303 may be connected through a bus or in another manner. The processor 1301 (or referred to as a CPU) is a computing core and a control core of the computer device, and may parse various instructions in the computer device and process various types of data of the computer device. For example, the CPU may be configured to parse a power-on/off instruction transmitted by an object to the computer device, and control the computer device to perform a power-on/off operation. For another example, the CPU may transmit various types of interaction data between structures inside the computer device. In some embodiments, the communication interface 1302 may include a standard wired interface and a standard wireless interface (for example, a Wi-Fi or mobile communication interface), and under control of the processor 1301, may be configured to receive and transmit data. The communication interface 1302 may be further configured to transmit and exchange data inside the computer device. The memory 1303 is a memory device of the computer device, and is configured to store a program and data. The memory 1303 herein may include a built-in memory of the computer device, or may include an extended memory supported by the computer device. The memory 1303 provides storage space, and an operating system of the computer device is stored in the storage space, including, but is not limited to, an Android system, an iOS system, a Windows Phone system, and the like. This is not limited in this disclosure.

An embodiment of this disclosure further provides a computer-readable storage medium (memory). The computer-readable storage medium is a memory device of a computer device, and is configured to store a program and data. The computer-readable storage medium herein may include a built-in storage medium of the computer device, or may include an extended storage medium supported by the computer device. The computer-readable storage medium provides storage space, and a processing system of the computer device is stored in the storage space. In addition, a computer program suitable for the processor 1301 to load and execute is further stored in the storage space. The computer-readable storage medium herein may be a high-speed RAM, or may be a non-volatile memory, for example, at least one magnetic disk memory. In the embodiments of this disclosure, the computer-readable storage medium may alternatively be at least one computer-readable storage medium located away from the foregoing processor.

In the embodiments of this disclosure, the processor 1301 performs the following operations by running the computer program in the memory 1303: obtaining bitstream data of an image; decoding the bitstream data to obtain a residual of a target block and a reference block of the target block, the target block being any unreconstructed block in the image; performing prediction on a chrominance component of the target block based on the reference block and a chrominance component prediction element, to obtain a predicted chrominance value of the target block, the chrominance component prediction element being at least two chrominance intra-frame prediction modes or a first luminance coefficient of the target block, and the first luminance coefficient being derived based on a pixel in the target block; and displaying the image based on the predicted chrominance value of the target block and the residual of the target block.

In the embodiments of this disclosure, the chrominance component prediction element is the at least two chrominance intra-frame prediction modes. A specific embodiment in which the processor 1301 performs prediction on the chrominance component of the target block based on the reference block and the chrominance component prediction element, to obtain the predicted chrominance value of the target block is: performing prediction on the chrominance component of the target block based on the reference block and a first chrominance intra-frame prediction mode, to obtain a first predicted value of the target block; performing prediction on the chrominance component of the target block based on the reference block and a second chrominance intra-frame prediction mode, to obtain a second predicted value of the target block; and performing weighted summation on the first predicted value and the second predicted value to obtain the predicted chrominance value of the target block.

In the embodiments of this disclosure, the target block includes a first region and a second region. A specific embodiment in which the processor 1301 performs weighted summation on the first predicted value and the second predicted value, to obtain the predicted chrominance value of the target block is: weighting the first predicted value separately by using a first weight corresponding to the first region and a second weight corresponding to the second region, to obtain a first weighting result and a second weighting result; weighting the second predicted value separately by using a third weight corresponding to the first region and a fourth weight corresponding to the second region, to obtain a third weighting result and a fourth weighting result; and summing the first weighting result, the second weighting result, the third weighting result, and the fourth weighting result to obtain the predicted chrominance value of the target block.

In the embodiments of this disclosure, the chrominance component prediction element is the first luminance coefficient of the target block. A specific embodiment in which the processor 1301 performs prediction on the chrominance component of the target block based on the reference block and the chrominance component prediction element, to obtain the predicted chrominance value of the target block is: obtaining a luminance difference value, the luminance difference value being configured for indicating a difference between the first luminance coefficient of the target block and a second luminance coefficient of the target block, and the second luminance coefficient of the target block being derived based on a pixel in a template region of the target block; calculating the first luminance coefficient of the target block based on the second luminance coefficient of the target block and the luminance difference value; and determining the predicted chrominance value of the target block based on the reference block and the first luminance coefficient of the target block.

In the embodiments of this disclosure, the target block includes a first region and a second region. A specific embodiment in which the processor 1301 determines the predicted chrominance value of the target block based on the reference block and the first luminance coefficient of the target block is: calculating a predicted chrominance value of the first region based on the reference block and the first luminance coefficient of the target block; calculating a predicted chrominance value of the second region based on the reference block and the second luminance coefficient of the target block; and determining the predicted chrominance value of the target block based on the predicted chrominance value of the first region and the predicted chrominance value of the second region.

In the embodiments of this disclosure, the chrominance component prediction element is the first luminance coefficient of the target block, and the target block includes a first region and a second region. A process in which the processor 1301 performs prediction on the chrominance component of the target block based on the reference block and the chrominance component prediction element, to obtain the predicted chrominance value of the target block includes: reconstructing a pixel in the first region by using a second luminance coefficient of the target block, the second luminance coefficient of the target block being derived based on a pixel in a template region of the target block; deriving the first luminance coefficient of the target block based on the reconstructed pixel in the first region; and determining a predicted chrominance value of the second region by using the first luminance coefficient of the target block.

In the embodiments of this disclosure, a specific embodiment in which the processor 1301 determines the predicted chrominance value of the second region by using the first luminance coefficient of the target block is: determining a luminance reconstruction block of the second region based on the reconstructed pixel, and determining the predicted chrominance value of the second region based on the luminance reconstruction block of the second region and the first luminance coefficient of the target block; or using the first luminance coefficient of the target block as a coefficient of a filter, and performing prediction on the chrominance component of the second region via the filter, to obtain the predicted chrominance value of the second region.

In another embodiment, the processor 1301 performs the following operations by running the computer program in the memory 1303: obtaining a reference block of a target block, the target block being any uncoded block in an image; performing prediction on a chrominance component of the target block based on the reference block and a chrominance component prediction element, to obtain a predicted chrominance value of the target block, the chrominance component prediction element being at least two chrominance intra-frame prediction modes or a first luminance coefficient of the target block, and the first luminance coefficient being derived based on a pixel in the target block; and determining a residual of the target block based on the predicted chrominance value of the target block, the residual of the target block being configured for generating bitstream data of the image.

In the embodiments of this disclosure, the chrominance component prediction element is the at least two chrominance intra-frame prediction modes. A specific embodiment in which the processor 1301 performs prediction on the chrominance component of the target block based on the reference block and the chrominance component prediction element, to obtain the predicted chrominance value of the target block is: performing prediction on the chrominance component of the target block based on the reference block and a first chrominance intra-frame prediction mode, to obtain a first predicted value of the target block; performing prediction on the chrominance component of the target block based on the reference block and a second chrominance intra-frame prediction mode, to obtain a second predicted value of the target block; and performing weighted summation on the first predicted value and the second predicted value to obtain the predicted chrominance value of the target block.

In the embodiments of this disclosure, the target block includes a first region and a second region. A specific embodiment in which the processor 1301 performs weighted summation on the first predicted value and the second predicted value, to obtain the predicted chrominance value of the target block is: weighting the first predicted value separately by using a first weight corresponding to the first region and a second weight corresponding to the second region, to obtain a first weighting result and a second weighting result; weighting the second predicted value separately by using a third weight corresponding to the first region and a fourth weight corresponding to the second region, to obtain a third weighting result and a fourth weighting result; and summing the first weighting result, the second weighting result, the third weighting result, and the fourth weighting result to obtain the predicted chrominance value of the target block.

In another embodiment, the chrominance component prediction element includes the first luminance coefficient of the target block. A specific embodiment in which the processor 1301 performs prediction on the chrominance component of the target block based on the reference block and the chrominance component prediction element, to obtain the predicted chrominance value of the target block is: determining the predicted chrominance value of the target block based on the reference block and the first luminance coefficient of the target block.

In the embodiments of this disclosure, the target block includes a first region and a second region. A specific embodiment in which the processor 1301 determines the predicted chrominance value of the target block based on the reference block (e.g., reference samples) of the target block and the first luminance coefficient of the target block is: deriving a second luminance coefficient of the target block based on a pixel value in a template region of the target block; calculating a predicted chrominance value of the first region based on the reference block and the first luminance coefficient of the target block; calculating a predicted chrominance value of the second region based on the reference block and the second luminance coefficient of the target block; and determining the predicted chrominance value of the target block based on the predicted chrominance value of the first region and the predicted chrominance value of the second region.

Based on a same inventive concept, a problem resolving principle and beneficial effects of the computer device provided in this embodiment of this disclosure are similar to a problem resolving principle and beneficial effects of the chrominance component prediction method in the method embodiment of this disclosure. Refer to the principle and the beneficial effects of implementation of the method. For brevity of description, details are not described herein again.

In the embodiments of this disclosure, the processor 1301 may be a CPU, or the processor 1301 may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor. Alternatively, the processor may be any related processor or the like.

An embodiment of this disclosure further provides a computer-readable storage medium. The computer-readable storage medium has a computer program stored therein. The computer program is suitable for a processor to load and execute, to implement the chrominance component prediction method in the method embodiment.

An embodiment of this disclosure further provides a computer program product or computer program. The computer program product or computer program includes computer instructions. The computer instructions are stored in a computer-readable storage medium. A processor of a computer device reads the computer instructions from the computer-readable storage medium. The processor executes the computer instructions, so that the computer device performs the chrominance component prediction method.

The operations in the method in the embodiments of this disclosure may be adjusted in terms of a sequence, combined, or deleted based on an actual requirement.

The modules in the apparatus in the embodiments of this disclosure may be combined, divided, or deleted based on an actual requirement.

In the embodiments of this disclosure, the term “module” or “unit” is a computer program with a preset function, or is a part of a computer program and operates, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

It is noted that all or some of the operations of the methods in the foregoing embodiments may be implemented by a program instructing related hardware. The program may be stored in a computer-readable storage medium. The storage medium may include a flash memory, a ROM, a RAM, a magnetic disk, an optical disk, or the like.

What is disclosed above is an example embodiment of this disclosure, and is not intended to limit the scope of this disclosure. It is noted that all or some of the procedures in the foregoing embodiments and equivalent variations made in accordance with the claims of this disclosure shall fall within the scope of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of video decoding, the method comprising:
receiving a bitstream that includes coded information of a picture;
decoding the bitstream to obtain a residual block of a current block in the picture;
generating at least a first prediction of a chrominance component of a first pixel in the current block and a second prediction of the chrominance component of the first pixel by respectively using at least two chrominance intra-frame prediction modes;
fusing at least the first prediction and the second prediction to obtain a first predicted chrominance value of the chrominance component of the first pixel; and
reconstructing the first pixel in the current block based on the first predicted chrominance value of the chrominance component of the first pixel and a first residual value of the first pixel in the residual block of the current block.

2. The method according to claim 1, wherein:
the first prediction of the chrominance component of the first pixel is generated based on one or more first reference samples;
the second prediction of the chrominance component of the first pixel is generated based on one or more second reference samples; and
the one or more second reference samples are from a different location from the one or more first reference samples.

3. The method according to claim 1, wherein:
the first prediction of the chrominance component of the first pixel is generated based on one or more first reference samples;
the second prediction of the chrominance component of the first pixel is generated based on one or more second reference samples; and
the one or more second reference samples are of a different color component from the one or more first reference samples.

4. The method according to claim 2, wherein the current block comprises at least a first region comprising at least the first pixel and a second region comprising at least a second pixel, and the method comprises:
determining, first weights respectively for at least the two chrominance intra-frame prediction modes for the first region;
fusing at least the first prediction and the second prediction to obtain the first predicted chrominance value of the chrominance component of the first pixel in the first region based on the first weights;
determining, second weights respectively for at least the two chrominance intra-frame prediction modes for the second region;
generating at least a third prediction of the chrominance component of the second pixel and a fourth prediction of the chrominance component of the second pixel by respectively using at least the two chrominance intra-frame prediction modes; and
fusing at least the third prediction and the fourth prediction to obtain a second predicted chrominance value of the chrominance component of the second pixel in the second region based on the second weights.

5. The method according to claim 1, wherein the fusing comprises:
weighting, at least the first prediction and the second prediction based on respective weight distributions of at least the two chrominance intra-frame prediction modes, to obtain at least a weighted first prediction and a weighted second prediction; and
merging at least the weighted first prediction and the weighted second prediction to obtain the first predicted chrominance value.

6. The method according to claim 1, wherein a first chrominance intra-frame prediction mode in at least the two chrominance intra-frame prediction modes is based on a first luminance coefficient, and the method further comprises:
obtaining a luminance difference value from the coded information in the bitstream;
deriving a second luminance coefficient based on one or more pixels in a template region of the current block; and
determining the first luminance coefficient of the current block based on the second luminance coefficient and the luminance difference value.

7. The method according to claim 6, wherein the current block comprises at least a first region including the first pixel and a second region including a second pixel, and the method comprises:
calculating the first predicted chrominance value of the first pixel based on the first luminance coefficient;
calculating a second predicted chrominance value of the second pixel based on the second luminance coefficient; and
reconstructing the current block based on the first predicted chrominance value of the first pixel and the second predicted chrominance value of the second pixel.

8. The method according to claim 1, wherein the current block comprises at least a first region including the first pixel and a second region including one or more second pixels, and the method comprises:
deriving a second luminance coefficient based on a template region of the current block;
reconstructing the one or more second pixels in the second region by using the second luminance coefficient;
deriving a first luminance coefficient based on the one or more second pixels that are reconstructed; and
determining the first predicted chrominance value of the first pixel by using the first luminance coefficient.

9. The method according to claim 8, wherein the determining the first predicted chrominance value comprises:
determining first luminance samples of the first region; and
determining the first predicted chrominance value of the first pixel based on the first luminance samples of the first region and the first luminance coefficient.

10. The method according to claim 8, wherein the determining the first predicted chrominance value comprises:
determining first luminance samples of the first region; and
filtering the first luminance samples by using a filter with the first luminance coefficient being a filter coefficient to obtain at least the first predicted chrominance value of the first pixel.

11. A method of video encoding, the method comprising:
generating at least a first prediction of a chrominance component of a first pixel in a current block of a picture and a second prediction of the chrominance component of the first pixel by respectively using at least two chrominance intra-frame prediction modes;
fusing at least the first prediction and the second prediction to obtain a first predicted chrominance value of the chrominance component of the first pixel;
determining a first residual value of the first pixel based on the first predicted chrominance value; and
encoding the current block into coded information in a bitstream based on at least the first residual value of the first pixel.

12. The method according to claim 11, wherein:
the first prediction of the chrominance component of the first pixel is generated based on one or more first reference samples;
the second prediction of the chrominance component of the first pixel is generated based on one or more second reference samples; and
the one or more second reference samples are from a different location from the one or more first reference samples.

13. The method according to claim 11, wherein:
the first prediction of the chrominance component of the first pixel is generated based on one or more first reference samples;
the second prediction of the chrominance component of the first pixel is generated based on one or more second reference samples; and
the one or more second reference samples are of a different color component from the one or more first reference samples.

14. The method according to claim 12, wherein the current block comprises at least a first region comprising at least the first pixel and a second region comprising at least a second pixel, and the method comprises:
determining, first weights respectively for at least the two chrominance intra-frame prediction modes for the first region;
fusing at least the first prediction and the second prediction to obtain the first predicted chrominance value of the chrominance component of the first pixel in the first region based on the first weights;
determining, second weights respectively for at least the two chrominance intra-frame prediction modes for the second region;
generating at least a third prediction of the chrominance component of the second pixel and a fourth prediction of the chrominance component of the second pixel by respectively using at least the two chrominance intra-frame prediction modes; and
fusing at least the third prediction and the fourth prediction to obtain a second predicted chrominance value of the chrominance component of the second pixel in the second region based on the second weights.

15. The method according to claim 11, wherein the fusing comprises:
weighting, at least the first prediction and the second prediction based on respective weight distributions of at least the two chrominance intra-frame prediction modes, to obtain at least a weighted first prediction and a weighted second prediction; and
merging at least the weighted first prediction and the weighted second prediction to obtain the first predicted chrominance value.

16. The method according to claim 11, wherein a first chrominance intra-frame prediction mode in at least the two chrominance intra-frame prediction modes is based on a first luminance coefficient, and the method further comprises:
deriving a second luminance coefficient based on one or more pixels in a template region of the current block; and
encoding a luminance difference value between the first luminance coefficient and the second luminance coefficient into the coded information in the bitstream.

17. The method according to claim 16, wherein the current block comprises at least a first region including the first pixel and a second region including a second pixel, and the method comprises:
calculating the first predicted chrominance value of the first pixel based on the first luminance coefficient; and
calculating a second predicted chrominance value of the second pixel based on the second luminance coefficient.

18. The method according to claim 11, wherein the current block comprises at least a first region including the first pixel and a second region including one or more second pixels, and the method comprises:
deriving a second luminance coefficient based on a template region of the current block;
reconstructing the one or more second pixels in the second region by using the second luminance coefficient;
deriving a first luminance coefficient based on the one or more second pixels that are reconstructed; and
determining the first predicted chrominance value of the first pixel by using the first luminance coefficient.

19. The method according to claim 18, wherein the determining the first predicted chrominance value comprises:
determining first luminance samples of the first region; and
determining the first predicted chrominance value of the first pixel based on the first luminance samples of the first region and the first luminance coefficient.

20. A non-transitory computer-readable storage medium storing instructions which when executed by a processor cause the processor to perform a method of encoding a bitstream, the method comprising:
generating at least a first prediction of a chrominance component of a first pixel in a current block of a picture and a second prediction of the chrominance component of the first pixel by respectively using at least two chrominance intra-frame prediction modes;
fusing at least the first prediction and the second prediction to obtain a first predicted chrominance value of the chrominance component of the first pixel;
determining a first residual value of the first pixel based on the first predicted chrominance value;
encoding the current block into coded information in the bitstream based on at least the first residual value of the first pixel; and
transmitting the bitstream.
